(19) United States
(12) Patent Application Publication
(10) Pub. No.: US 2025/0229523 A1
(43) Pub. Date: Jul. 17, 2025

(54) LIQUID EJECTING HEAD, LIQUID EJECTING APPARATUS, AND METHOD OF DETECTING STATE of LIQUID EJECTING HEAD

(71) Applicant: SEIKO EPSON CORPORATION, Tokyo (JP)

(72) Inventor: Yuichi KATANIWA, SHIOJIRI-SHI (JP)

(21) Appl. No.: 19/014,312

(22) Filed: Jan. 9, 2025

(30) Foreign Application Priority Data
Jan. 12, 2024 (JP) 2024-003078

(51) Int. Cl. B41J 2/045; B41J 2/14; B41J 2/175

(52) U.S. Cl. CPC B41J 2/0451; B41J 2/04581; B41J 2/14233; B41J 2/1433; B41J 2/17563; B41J 2/17596

(57) ABSTRACT

A liquid ejecting head includes nozzles, a common liquid chamber communicating with the nozzles, a filter partitioning the common liquid chamber into an upstream chamber and a downstream chamber, a flexible member defining the downstream chamber of the common liquid chamber, and a detection section configured to detect a position of the flexible member. The flexible member disposed between the downstream chamber and the detection section.

The present application is based on, and claims priority from JP Application Serial Number 2024-003078, filed Jan. 12, 2024, the disclosure of which is hereby incorporated by reference herein in its entirety.

### BACKGROUND

### 1. Technical Field

The present disclosure relates to a liquid ejecting head that ejects a liquid from a nozzle and is provided with a filter inside thereof, a liquid ejecting apparatus including the liquid ejecting head, and a method of detecting a state of the liquid ejecting head.

### 2. Related Art

A liquid ejecting apparatus represented by an ink jet type recording apparatus, such as an ink jet type printer, includes a liquid ejecting head that can eject a liquid, such as ink stored in a cartridge, a tank or the like, as liquid droplets.

The liquid ejecting head includes a nozzle for ejecting the liquid droplets, a pressure chamber communicating with the nozzle, a drive element that causes a pressure change in a liquid in the pressure chamber, and a common liquid chamber communicating with a plurality of the pressure chambers, and ejects the liquid droplets from the nozzle by causing the pressure change in the liquid in the pressure chamber by driving the drive element. In addition, a liquid ejecting head provided with a filter for removing foreign matters such as dust and air bubbles contained in the liquid in the common liquid chamber is proposed (for example, see JP-A-2023-98016).

However, when the filter provided in the liquid ejecting head is clogged with foreign matter such as dust and air bubbles contained in the liquid, there is a problem that the liquid is not normally supplied to the downstream through the filter and the liquid ejection failure occurs. Therefore, it is desired to detect the degree of clogging of the filter provided inside the liquid ejecting head.

### SUMMARY

According to an aspect of the present disclosure, there is provided a liquid ejecting head including: a plurality of nozzles that eject a liquid; a common liquid chamber that communicates with the plurality of nozzles; a filter that partitions the common liquid chamber into an upstream chamber and a downstream chamber; a flexible member that defines the downstream chamber of the common liquid chamber; and a detection section that is disposed on a side opposite to a surface of the flexible member that defines the downstream chamber and detects a position of the flexible member.

According to another aspect of the present disclosure, there is provided a liquid ejecting apparatus including the liquid ejecting head according to the above aspect.

According to still another aspect of the present disclosure, there is provided a method of detecting a state of the liquid ejecting head according to the above aspect, the method including estimating a degree of clogging of the filter based on first information on a position of the flexible member detected by the detection section before a pressure applying operation of applying the pressure inside the common liquid chamber is performed and second information on the position of the flexible member detected by the detection section while the pressure applying operation is performed.

According to still another aspect of the present disclosure, there is provided a method of detecting a state of the liquid ejecting head according to the above aspect, the method including estimating a degree of clogging of the filter based on third information on the position of the flexible member detected by the detection section while a pressure applying operation of applying the pressure into the common liquid chamber is performed at a first timing at which the filter is not clogged and fourth information on the position of the flexible member detected by the detection section while the pressure applying operation is performed at a second timing later than the first timing.

### BRIEF DESCRIPTION OF THE DRAWINGS

FIG. 1 is a view illustrating a schematic configuration of a liquid ejecting apparatus according to a first embodiment.

FIG. 2 is an exploded perspective view of a liquid ejecting head according to the first embodiment.

FIG. 3 is a plan view of a pressure chamber substrate according to the first embodiment.

FIG. 4 is a sectional view of the liquid ejecting head according to the first embodiment.

FIG. 5 is a plan view of the liquid ejecting head according to the first embodiment.

FIG. 6 is a sectional view of a main portion illustrating a state of the liquid ejecting head according to the first embodiment.

FIG. 7 is a sectional view of the main portion illustrating the state of the liquid ejecting head according to the first embodiment.

FIG. 8 is a sectional view of the main portion illustrating the state of the liquid ejecting head according to the first embodiment.

FIG. 9 is a sectional view of the main portion illustrating the state of the liquid ejecting head according to the first embodiment.

FIG. 10 is a sectional view of the main portion illustrating the state of the liquid ejecting head according to the first embodiment.

FIG. 11 is a flowchart for explaining a state detection method according to the first embodiment.

FIG. 12 is an exploded perspective view of a liquid ejecting head according to a second embodiment.

FIG. 13 is a sectional view of the liquid ejecting head according to the second embodiment.

FIG. 14 is an enlarged sectional view of a main portion of the liquid ejecting head according to the second embodiment.

FIG. 15 is a table illustrating a state determination method of the liquid ejecting head according to the second embodiment.

FIG. 16 is a view illustrating a schematic configuration of a liquid ejecting apparatus

according to a third embodiment.

FIG. 17 is a table illustrating a state determination method of the liquid ejecting head according to the third embodiment.

### DESCRIPTION OF EMBODIMENTS

Hereinafter, the present disclosure will be described in detail based on embodiments. However, the following description illustrates an aspect of the present disclosure, and can be freely changed within the scope of the present disclosure. Those having the same reference signs in each of the drawings indicate the same members, and the description thereof is omitted as appropriate. In each of the drawings, X, Y, and Z represent three spatial axes perpendicular to each other. In the present specification, directions along these axes are set as an X direction, a Y direction, and a Z direction. A direction where the arrow in each of the drawings is directed is a positive (+) direction, and a direction opposite to the arrow is a negative (−) direction. In addition, the Z direction indicates a vertical direction, the +Z direction indicates a vertically downward direction, and the −Z direction indicates a vertically upward direction. Furthermore, the directions of three spatial axes that do not limit the positive direction and the negative direction will be described as an X-axis direction, a Y-axis direction, and a Z-axis direction.

### First Embodiment

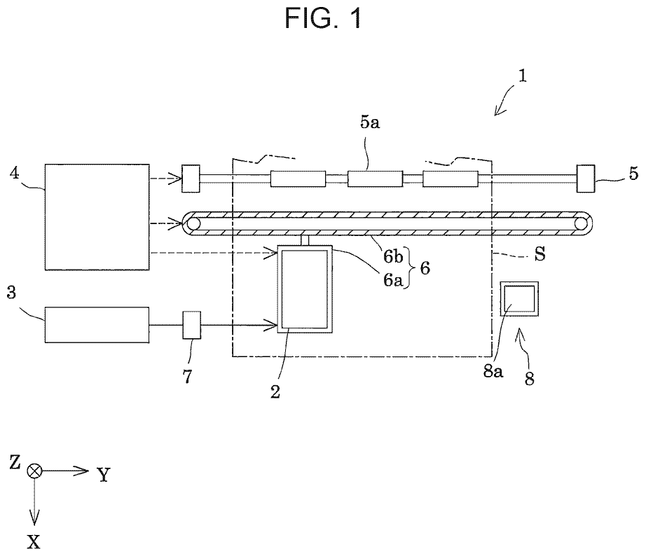

FIG. 1 is a view illustrating a schematic configuration of a liquid ejecting apparatus 1 according to a first embodiment of the present disclosure.

As illustrated in FIG. 1, the liquid ejecting apparatus 1 is a so-called serial printer that includes a liquid ejecting head 2 and performs printing by ejecting a liquid from the liquid ejecting head 2 toward a medium S in the +Z direction while transporting the medium S in the X-axis direction and reciprocating the liquid ejecting head 2 in the Y-axis direction. As the medium S, any material such as recording paper or a resin film can be used in addition to cloth.

The liquid ejecting apparatus 1 includes a liquid ejecting head 2, a liquid storage portion 3, a control section 4, a transport mechanism 5 that feeds out a medium S, and a moving mechanism 6.

Examples of the liquid storage portion 3 include a cartridge that can be attached to and detached from the liquid ejecting apparatus 1, a bag-shaped ink pack formed of a flexible film, an ink tank that can be refilled with ink, and the like. Further, the liquid storage portion 3 may be divided into a main tank and a sub tank. The sub tank may be coupled to the liquid ejecting head 2, and the sub tank is refilled with the liquid consumed by ejecting the liquid droplets from the liquid ejecting head 2 from the main tank.

The ink in the liquid storage portion 3 is fed to the liquid ejecting head 2 via a pressure-feeding unit 7. Examples of the pressure-feeding unit 7 include a pressing unit that presses the liquid storage portion 3 from the outside, a pressurizing pump, and the like. As the pressure-feeding unit, a head pressure difference generated by adjusting the relative position of the liquid ejecting head 2 and the liquid storage portion 3 in the vertical direction may be used. In the present embodiment, a pressurizing pump is used as the pressure-feeding unit 7.

The control section 4 comprehensively controls each element of the liquid ejecting apparatus 1, that is, the liquid ejecting head 2, the transport mechanism 5, the moving mechanism 6, and the like. The control section 4 includes, for example, a control device such as a central processing unit (CPU) or a field programmable gate array (FPGA), and a storage device such as a semiconductor memory. The control section 4 also includes a power supply device that supplies power supplied from an external power supply such as a commercial power supply to each element of the liquid ejecting apparatus 1. The control section 4 is electrically coupled to the liquid ejecting head 2 via an external wire (not illustrated). The control section 4 comprehensively controls each element of the liquid ejecting apparatus 1 by the control device executing a program stored in the storage device.

The transport mechanism 5 transports the medium S in the X-axis direction, and includes, for example, a transport roller 5a that is rotated by a transport motor that is driven and controlled by the control section 4.

The moving mechanism 6 is a mechanism for reciprocating the liquid ejecting head 2 in the Y-axis direction, and includes a holding body 6a that holds the liquid ejecting head 2 and a transport belt 6b that is an endless belt erected along the Y-axis direction. The control section 4 rotates the transport belt 6b by controlling the drive of a transport motor (not illustrated) to reciprocate the liquid ejecting head 2 in the Y-axis direction together with the holding body 6a fixed to the transport belt 6b.

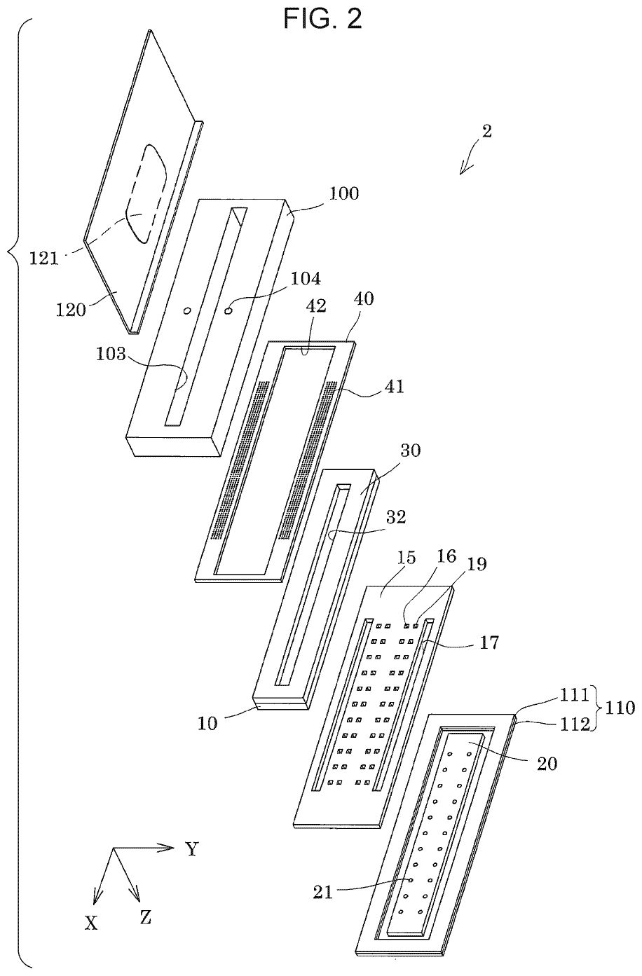

Under the control of the control section 4, the liquid ejecting head 2 performs an ejection operation of ejecting ink supplied from the liquid storage portion 3 as ink droplets from each of the plurality of nozzles 21 (refer to FIG. 2) in the +Z direction. The ejection operation by the liquid ejecting head 2 is performed in parallel with the transporting of the medium S by the transport mechanism 5 and the reciprocating movement of the liquid ejecting head 2 by the moving mechanism 6, so that so-called printing in which the ink is applied to the medium S is performed.

Further, the liquid ejecting apparatus 1 is provided with a maintenance unit 8 for performing maintenance such as cleaning of the liquid ejecting head 2 in a home position region of the holding body 6a. The maintenance unit 8 includes a cap 8a that abuts on the liquid ejecting head 2 so as to surround each nozzle 21 of the liquid ejecting head 2 or that receives the ink ejected from each nozzle 21 by flushing, and a suction pump (not illustrated) that can suck the inside of the cap 8a. Then, the so-called suction cleaning is performed by sucking the inside of the cap 8a by the suction pump in a state in which the cap 8a abuts on the liquid ejecting head 2 so as to surround each nozzle 21 of the liquid ejecting head 2, and the thickened ink, air bubbles, and the like are forcibly discharged from each nozzle 21 into the cap 8a.

Further, the liquid ejecting apparatus 1 performs a so-called pressurization cleaning in which the ink is discharged from the nozzle 21 by pressure-feeding the ink in the liquid storage portion 3 by the pressure-feeding unit 7 to the liquid ejecting head 2 without driving a piezoelectric actuator 300 of the liquid ejecting head 2, which will be described in detail later. The pressure-feeding unit 7 is not limited to the configuration that pressurizes the ink in the liquid storage portion 3, and may perform the pressurization cleaning by pressurizing the flow path upstream of the pressure chamber 12 by the pressure-feeding unit 7. Also when performing the pressurization cleaning, the ink discharged from the nozzle 21 may be discharged into the cap 8a. Of course, the ink discharged from the nozzle 21 may be received by a cap different from the cap 8a when the pressurization cleaning is performed.

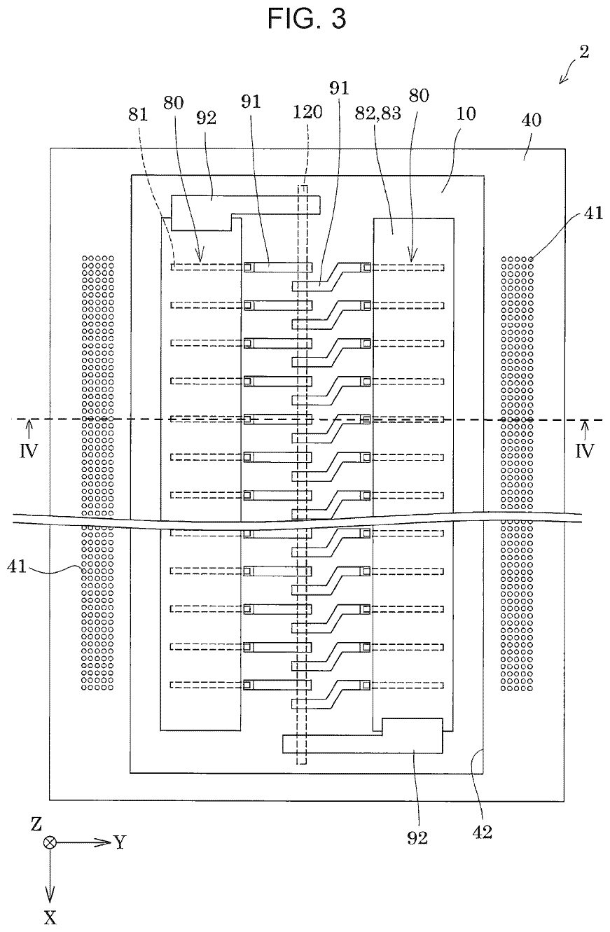

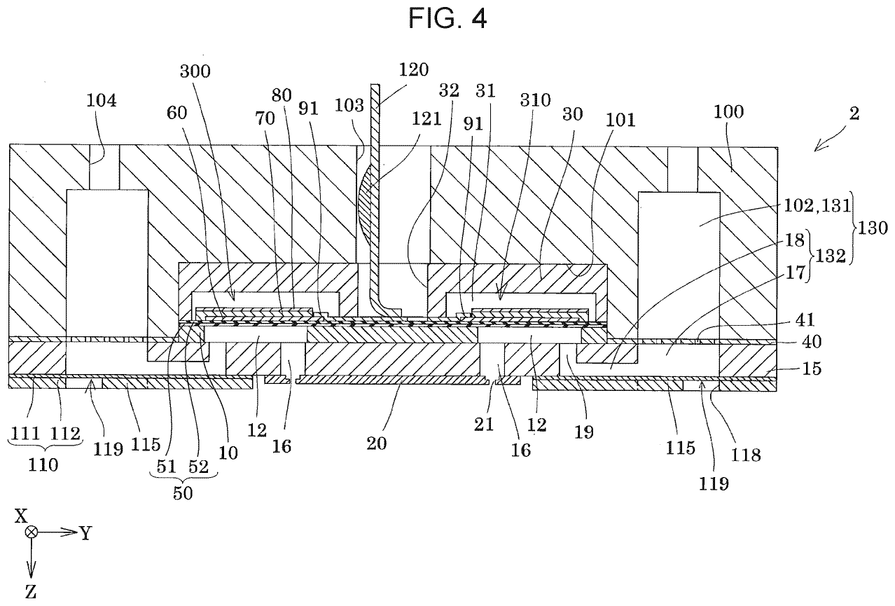

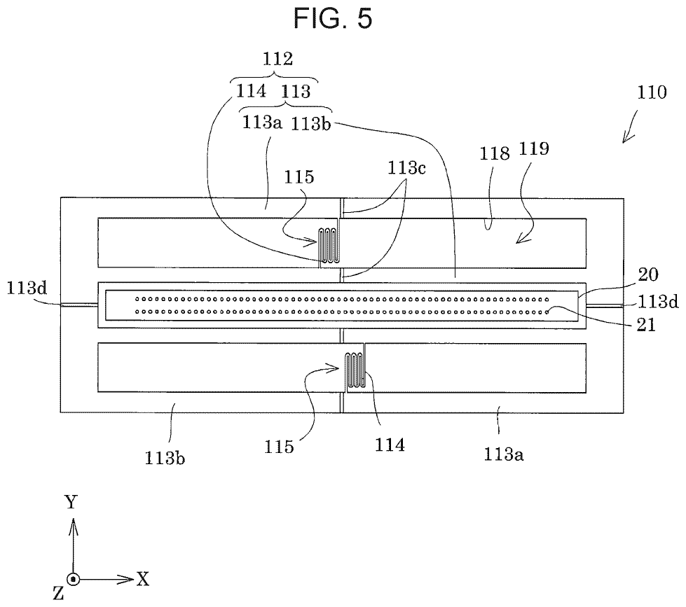

FIG. 2 is an exploded perspective view of the liquid ejecting head 2. FIG. 3 is a plan view of the pressure chamber substrate 10 in a state of being incorporated in the liquid ejecting head 2. FIG. 4 is a sectional view of the liquid ejecting head 2 taken along line IV-IV of FIG. 3. FIG. 5 is a plan view of the liquid ejecting head 2 when viewed in the-Z direction. Each direction of the liquid ejecting head 2 will be described based on the directions when the liquid ejecting head 2 is mounted on the liquid ejecting apparatus 1, that is, the X-axis direction, the Y-axis direction, and the Z-axis direction.

As illustrated in the drawings, the liquid ejecting head 2 of the present embodiment includes a pressure chamber substrate 10, a communication plate 15, a nozzle plate 20 on which a plurality of nozzles 21 are formed, a protective substrate 30, a case 100, a piezoelectric actuator 300, and a wiring member 120.

The pressure chamber substrate 10 is made of, for example, a silicon substrate or the like. The plurality of pressure chambers 12 are arranged side by side on the pressure chamber substrate 10 along the X-axis direction. The plurality of pressure chambers 12 are disposed on a straight line along the X-axis direction such that positions in the Y-axis direction are the same. The two pressure chambers 12 adjacent to each other in the X-axis direction are partitioned by partition walls which are not illustrated. In addition, in the present embodiment, two rows of pressure chambers 12 in which the pressure chambers 12 are arranged side by side in the X-axis direction are provided in the Y-axis direction.

The communication plate 15 and the nozzle plate 20 are sequentially laminated on the surface of the pressure chamber substrate 10 facing the +Z direction. A vibration plate 50 and a piezoelectric actuator 300 are sequentially laminated on the surface of the pressure chamber substrate 10 facing the −Z direction.

The communication plate 15 is a plate-shaped member joined to a surface of the pressure chamber substrate 10 facing the +Z direction. The communication plate 15 is provided with a nozzle communication path 16 that makes the pressure chamber 12 and the nozzle 21 communicate with each other. The communication plate 15 is provided with a first common liquid chamber portion 17 and a second common liquid chamber portion 18 that configure a common liquid chamber 130 through which the plurality of pressure chambers 12 communicate in common. The first common liquid chamber portion 17 is provided to penetrate the communication plate 15 in the Z-axis direction. The second common liquid chamber portion 18 is provided to be open on the surface facing the +Z direction without penetrating the communication plate 15 in the Z-axis direction. The communication plate 15 is provided with a supply communication passage 19 that communicates with one end portion of the pressure chamber 12 in the Y-axis direction, independently for each pressure chamber 12. The supply communication passage 19 causes the second common liquid chamber portion 18 and the pressure chamber 12 to communicate with each other, and supplies the ink in the common liquid chamber 130 to the pressure chamber 12. As such a communication plate 15, a silicon substrate or the like can be used.

The nozzle plate 20 is joined to the surface of the communication plate 15 facing the +Z direction. The nozzle plate 20 is formed with the nozzle 21 that communicates with each of the pressure chambers 12 through the nozzle communication path 16. In the present embodiment, the plurality of nozzles 21 are disposed to be arranged in a row along the X-axis direction. In the present embodiment, two nozzle rows, in which the nozzles 21 are arranged side by side along the X-axis direction, are provided at a distance in the Y-axis direction.

The material of the nozzle plate 20 is not particularly limited, and for example, a silicon substrate or the like can be used.

The vibration plate 50 includes, for example, an elastic film 51 made of silicon oxide provided on the pressure chamber substrate 10 side, and an insulator film 52 made of zirconium oxide provided on the surface of the elastic film 51 facing the −Z direction.

The piezoelectric actuator 300 includes a first electrode 60 sequentially laminated on the vibration plate 50 in the −Z direction, a piezoelectric body layer 70 made of a piezoelectric material formed of a perovskite structure composite oxide represented by, for example, a general formula ABO₃, and a second electrode 80. Such a piezoelectric actuator 300 is also referred to as a piezoelectric element, and refers to a portion including the first electrode 60, the piezoelectric body layer 70, and the second electrode 80. In addition, a portion where piezoelectric strain occurs in the piezoelectric body layer 70 when a voltage is applied between the first electrode 60 and the second electrode 80 is referred to as an active portion 310. Meanwhile, a portion where piezoelectric strain does not occur in the piezoelectric body layer 70 is referred to as an inactive portion. That is, the active portion 310 refers to a portion where the piezoelectric body layer 70 is interposed between the first electrode 60 and the second electrode 80. In the present embodiment, the active portion 310 is formed for each pressure chamber 12. That is, a plurality of active portions 310 are formed at the piezoelectric actuator 300. The plurality of active portions 310 are drive elements that cause a pressure change in the ink in the pressure chamber 12. In general, any one of the electrodes of the active portion 310 is configured as an independent individual electrode for each active portion 310, and the other electrode is configured as a common electrode common to the plurality of active portions 310. In the present embodiment, the first electrode 60 is configured as an individual electrode, and the second electrode 80 is configured as a common electrode.

An individual lead electrode 91, which is a lead-out wiring, is drawn out from the first electrode 60. A common lead electrode 92, which is a lead-out wiring, is drawn out from the second electrode 80. The wiring member 120 formed of a flexible substrate having flexibility is coupled to the end portions of the individual lead electrode 91 and an end portion of the common lead electrode 92 on a side opposite to an end portion thereof coupled to the piezoelectric actuator 300. A drive circuit 121 is mounted on the wiring member 120. The drive circuit 121 has a plurality of switching elements for selecting whether or not to supply a drive signal COM for driving each active portion 310 to each active portion 310. That is, the wiring member 120 in the present embodiment is a chip-on-film (COF). The wiring member 120 may not be provided with the drive circuit 121. That is, the wiring member 120 may be a flexible flat cable (FFC), a flexible printed circuits (FPC), and the like.

As illustrated in FIGS. 2 and 4, the protective substrate 30 having substantially the same size as the pressure chamber substrate 10 is joined to the surface of the pressure chamber substrate 10 facing the −Z direction. The protective substrate 30 includes an accommodation portion 31 which is a space for protecting the piezoelectric actuator 300. The accommodation portion 31 is independently provided for each row of the piezoelectric actuators 300 disposed to be arranged in the X-axis direction, and two accommodation portions 31 are formed to be arranged in the Y-axis direction. A through-hole 32 penetrating in the Z-axis direction is provided between the two accommodation portions 31 disposed to be arranged in the Y-axis direction, in the protective substrate 30. The end portions of the individual lead electrode 91 and the common lead electrode 92 drawn out from the electrodes of the piezoelectric actuator 300 are extended to be exposed in the through-hole 32, and the individual lead electrode 91 and the common lead electrode 92 are electrically coupled to the wiring member 120 in the through-hole 32. Such a protective substrate 30 is made of, for example, a silicon substrate.

The filter 40 is joined to the surface of the communication plate 15 facing the −Z direction. In FIG. 2, a region in which a filter hole 41 is provided in a surface of the filter 40 facing the +Z direction is illustrated only by hatching, and the illustration of the individual filter holes 41 is omitted.

In the present embodiment, the outer shape of the filter 40 has a substantially the same shape as the outer shape of the communication plate 15 in a plan view in the +Z direction. Further, the filter 40 has an opening portion 42 in which a region facing the pressure chamber substrate 10 is removed in the Z-axis direction. The filter 40 is provided on the surface of the communication plate 15 facing the −Z direction in a state in which the pressure chamber substrate 10 is disposed inside the opening portion 42.

The filter 40 is provided with a plurality of filter holes 41 in a region facing the first common liquid chamber portion 17 in a plan view when viewed in the +Z direction.

The filter 40 is an electroforming filter made of a metal plate such as Ni or Pd-Ni. The filter hole 41 is a through-hole penetrating the filter 40 in the Z-axis direction. The filter hole 41 has a circular opening when viewed in a plan view in the Z-axis direction. Of course, the shape of the filter hole 41 is not limited to a circle. The filter 40 may be formed by laminating a plurality of substrates.

The case 100 is fixed to a surface of the filter 40 facing the −Z direction. The case 100 has a substantially the same shape as the outer shape of the filter 40 in a plan view when viewed in the +Z direction. The case 100 has an opening on a surface facing the +Z direction, and has an accommodation portion 101 which is a space having a depth for accommodating the pressure chamber substrate 10 and the protective substrate 30. An opening surface of the accommodation portion 101 on the pressure chamber substrate 10 side is sealed by the vibration plate 50 in a state in which the pressure chamber substrate 10 and the protective substrate 30 are accommodated in the accommodation portion 101. Further, the case 100 is provided with a wiring insertion hole 103 through which the wiring member 120 is inserted in communication with the through-hole 32 of the protective substrate 30. Ink introduction portions 102 are defined on both the outer sides of the case 100 in the Y-axis direction. The case 100 is provided with an introduction port 104 for communicating with the ink introduction portion 102 and supplying the ink to each ink introduction portion 102.

The common liquid chamber 130 of the present embodiment is configured by the first common liquid chamber portion 17 and the second common liquid chamber portion 18 of the communication plate 15 and the ink introduction portion 102 of the case 100. The common liquid chamber 130 is continuously provided in the X-axis direction, which is the direction in which the pressure chambers 12 are provided in parallel, and the supply communication passage 19 that communicates each pressure chamber 12 with the common liquid chamber 130 is disposed to be arranged in the X-axis direction. That is, the common liquid chamber 130 has a substantially rectangular shape having a longitudinal direction along the X-axis direction and a short direction along the Y-axis direction when viewed in a plan view in the Z-axis direction.

The filter 40 is provided between the communication plate 15 and the case 100, and the filter 40, the communication plate 15 and the case 100 are bonded to each other by an adhesive. In this manner, the communication plate 15, the filter 40, and the case 100 are laminated in this order in the −Z direction by the adhesive, so that the first common liquid chamber portion 17 and the ink introduction portion 102 communicate with each other via the filter hole 41 of the filter 40. That is, the filter 40 partitions the common liquid chamber 130 into the upstream chamber 131 configured by the ink introduction portion 102 and the downstream chamber 132 configured by the first common liquid chamber portion 17 and the second common liquid chamber portion 18.

In addition, a compliance substrate 110 is provided on the surface of the communication plate 15 on the +Z direction side where the first common liquid chamber portion 17 and the second common liquid chamber portion 18 are open. The compliance substrate 110 seals an opening of the downstream chamber 132 on the +Z direction side. In the present embodiment, the compliance substrate 110 includes a flexible member 111 having a thin film shape and flexibility formed of a material such as a resin or metal, and a frame member 112 formed of a hard material of metal or the like such as stainless steel. The flexible member 111 and the frame member 112 are laminated in this order on a surface of the communication plate 15 facing the +Z direction. That is, the flexible member 111 defines the downstream chamber 132. In addition, since at least a part of the region of the frame member 112 facing the downstream chamber 132 is an opening portion 118 that is completely removed in the thickness direction, a part of the surface of the downstream chamber 132 facing the +Z direction is a compliance portion 119 that is a flexible portion sealed only by the flexible member 111 having flexibility. That is, the frame member 112 defines a compliance space in which the compliance portion 119 is bendable and deformable inside the opening portion 118. In the present embodiment, the compliance portion 119 is provided in a region that overlaps the first common liquid chamber portion 17 when viewed in the Z-axis direction. Of course, the compliance portion 119 may be provided in a region that overlaps both the first common liquid chamber portion 17 and the second common liquid chamber portion 18 when viewed in the Z-axis direction. In addition, the compliance substrate 110 is not particularly limited thereto, and for example, the compliance portion 119 may be provided by forming a recessed portion in a part of one substrate. The bending rigidity of the compliance portion 119 is smaller than the bending rigidity of the region of the filter 40 provided with the filter holes 41.

In such a liquid ejecting head 2, the ink is supplied from the introduction port 104 coupled to the liquid storage portion 3 to the upstream chamber 131 configured by the ink introduction portion 102. The ink in the upstream chamber 131 is supplied to the downstream chamber 132 including the first common liquid chamber portion 17 and the second common liquid chamber portion 18 after the foreign matter such as dust and air bubbles contained in the ink is removed by the filter 40. Then, the inside from the common liquid chamber 130 including the upstream chamber 131 and the downstream chamber 132 to the nozzle 21 is filled with the ink, and then, a voltage is applied to each of the active portions 310 corresponding to the pressure chambers 12 according to the recording signal from the drive circuit 121. As a result, the vibration plate 50 is bent and deformed together with the active portion 310, the pressure of the ink in each pressure chamber 12 is increased, and the ink droplets are ejected from each nozzle 21.

Further, the liquid ejecting head 2 includes a detection section 115 for detecting the position of the compliance portion 119 on a surface is opposite to a surface of the flexible member 111 defining the downstream chamber 132, that is, in the present embodiment, a surface of the flexible member 111 facing the +Z direction. The detection section 115 of the present embodiment is fixed to the surface of the flexible member 111 facing the +Z direction, and is formed of a strain gauge that measures the amount of deformation of the compliance portion 119. The strain gauge is attached to a measurement target object, and measures a strain amount in multiple stages by an electrical resistance value that changes by stretching and contracting in proportion to the stretching and contracting of the measurement target object. The electrical resistance value detected by the strain gauge is detected, for example, as a voltage change. By using the strain gauge as the detection section 115, the position of the compliance portion 119, that is, the amount of deformation can be detected in multiple stages. The detection section 115 of the present embodiment is configured with a part of the frame member 112. Here, as illustrated in FIG. 5, the frame member 112 includes an outer peripheral frame portion 113 formed of a conductive material such as stainless steel and defining the opening portion 118, and a beam portion 114 provided integrally with the outer peripheral frame portion 113 and provided in the opening portion 118 for coupling the outer peripheral frame portions 113 to each other. The detection section 115 is configured by the beam portion 114. The beam portion 114 is disposed to cross the opening portion 118 in the Y-axis direction. In addition, the beam portion 114 is provided to meander in a zigzag in an XY plane defined by the X axis and the Y axis in the opening portion 118. That is, the beam portion 114 is provided to meander in the X-axis direction while reciprocating in the Y-axis direction. By providing the beam portion 114 to meander in a zigzag manner as described above, the beam portion 114 can be lengthened in the Y-axis direction, which is the bending direction of the flexible member 111, and the beam portion 114 is formed of a material having a high electrical resistance value. Therefore, the beam portion 114 is a strain gauge having good sensitivity to the amount of deformation of the compliance portion 119.

The beam portion 114 is disposed at a central portion of the flexible member 111 in the longitudinal direction of the common liquid chamber 130, that is, in the X-axis direction in the present embodiment. Here, the fact that the beam portion 114 is disposed at the central portion of the common liquid chamber 130 in the longitudinal direction means that the beam portion 114 is provided at the central portion when the region of the flexible member 111 facing the common liquid chamber 130 in the Z-axis direction is divided into three in the X-axis direction which is the longitudinal direction, and more preferably, the beam portion 114 is provided at the central portion when the region is divided into five in the longitudinal direction.

Further, the outer peripheral frame portion 113 includes a conductive portion 113a which is continuous with one end portion and the other end portion of the beam portion 114, and a non-conductive portion 113b which is not conductive with the beam portion 114. The conductive portion 113a and the non-conductive portion 113b are divided by two slits 113c. In the present embodiment, since two compliance portions 119 are provided on the compliance substrate 110, the outer peripheral frame portion 113 further includes two slits 113d for electrically separating the regions of the two compliance portions 119. That is, the outer peripheral frame portion 113 has two conductive portions 113a and two non-conductive portions 113b. For example, the conductive portion 113a is led out from the end portion in the X-axis direction to the pressure chamber substrate 10, in fact, to the vibration plate 50 via a wire (not illustrated), and is electrically coupled to the wiring member 120. As a result, the voltage change of the beam portion 114, which is the detection section 115, can be detected via the conductive portion 113a, the wire (not illustrated), and the wiring member 120. The conductive portion 113a of the present embodiment is an example of a “first portion”, and the non-conductive portion 113b is an example of a “second portion”.

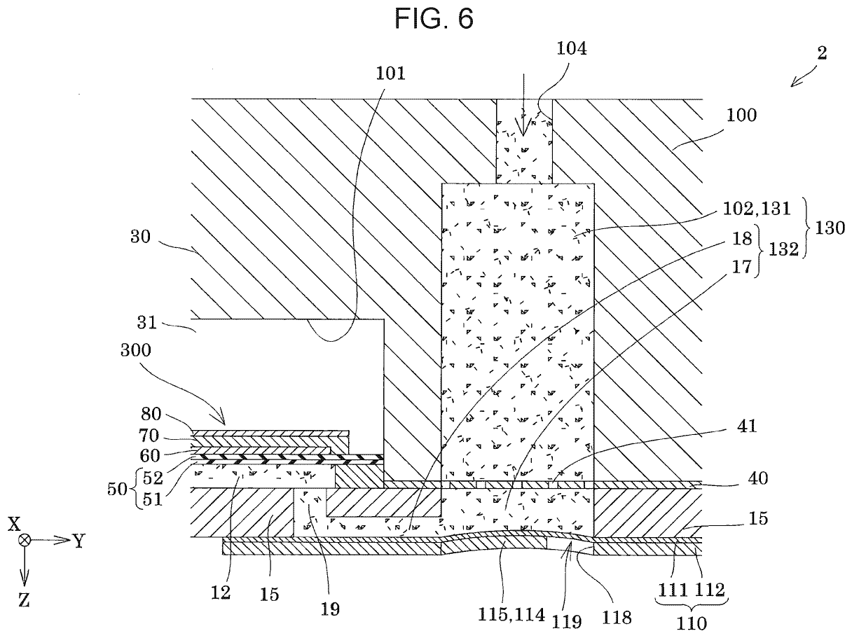

Here, a relationship between the clogging of the filter 40 when the suction cleaning is performed and the deformation of the compliance portion 119 is illustrated in FIGS. 6 to 8. FIGS. 6 to 8 are sectional views of main portions illustrating the state of the liquid ejecting head 2.

When the filter 40 is not clogged and the nozzle 21 is in a standby state (non-ejection state) in which the meniscus of the ink is formed in the nozzle 21 so that the ink droplets can be ejected by printing or the like by filling the flow path in the liquid ejecting head 2 with the ink, as illustrated in FIG. 6, the common liquid chamber 130 has a negative pressure, and the compliance portion 119 is bent and deformed in a convex shape toward the common liquid chamber 130 side, that is, in the −Z direction. The pressure in the downstream chamber 132 at this time is used as a reference, and the position of the compliance portion 119 is used as a reference. Further, the detection section 115 outputs, to the control section 4, a detection voltage E which is a voltage value corresponding to the electrical resistance value corresponding to the position of the compliance portion 119 at the timing of the detection via a not-illustrated wire. The detection voltage E detected by the detection section 115 at the position of the compliance portion 119 in the standby state illustrated in FIG. 6 is set as a reference voltage E0. The reference voltage E0 is an example of “first information regarding the position of the flexible member detected by the detection section before the pressure applying operation of applying the pressure in the common liquid chamber is performed”.

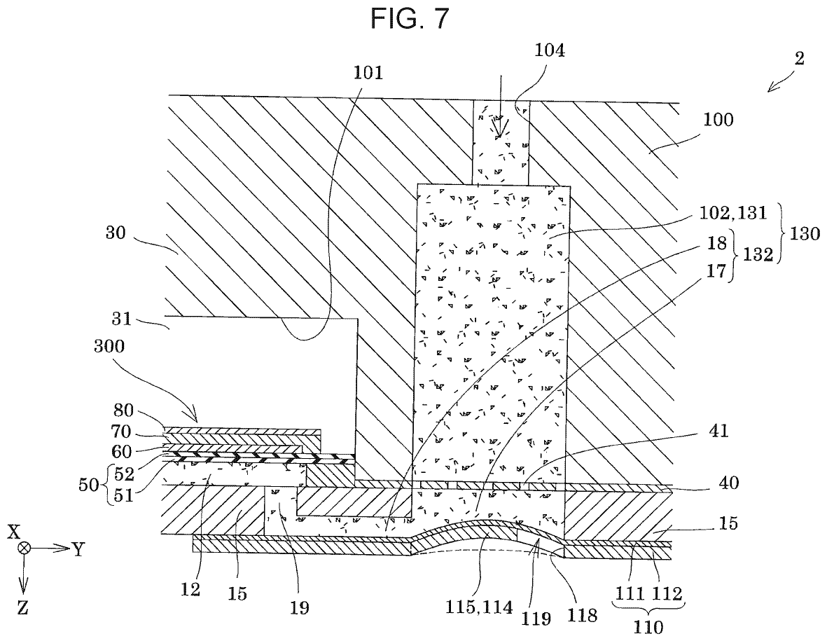

When the nozzle 21 is covered with the cap 8a and the suction cleaning is performed in a state in which the filter 40 is not clogged, as illustrated in FIG. 7, the downstream chamber 132 becomes a negative pressure by the suction from the nozzle 21, and the ink is supplied from the upstream chamber 131 to the downstream chamber 132 via the filter hole 41. In this case, the pressure in the downstream chamber 132 becomes a negative pressure with respect to the reference, and the compliance portion 119 is bent and deformed in a convex shape toward the common liquid chamber 130 side, that is, in the −Z direction, more than the reference position. The control section 4 calculates a voltage change ΔE1 from the reference voltage E0 to the detection voltage E detected by the detection section 115 at this time. The dotted line in FIG. 7 indicates the position of the compliance portion 119 in FIG. 6.

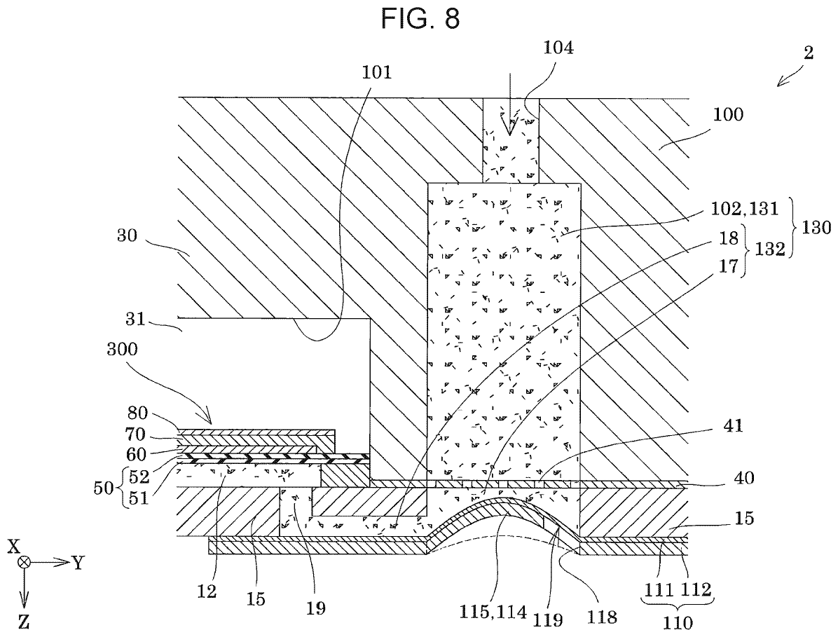

In addition, when the suction cleaning is performed in a state in which the filter 40 is clogged, as illustrated in FIG. 8, although the negative pressure is generated in the downstream chamber 132 by the suction from the nozzle 21, the pressure loss due to the filter 40 increases, and the supply of the ink from the upstream chamber 131 to the downstream chamber 132 is reduced. Therefore, the negative pressure in the downstream chamber 132 becomes larger than that in FIG. 7, and the compliance portion 119 is largely deformed from the reference position. That is, a voltage change ΔE2 from the reference voltage E0 calculated by the control section 4 to the detection voltage E detected by the detection section 115 at this time is larger than the voltage change ΔE1. The dotted line in FIG. 8 indicates the position of the compliance portion 119 in FIG. 7.

Here, the state in which the filter 40 is clogged means a state in which at least a part of the plurality of filter holes 41 is blocked by a foreign matter. In addition, the state in which the filter 40 is clogged includes a state in which the filter holes 41 are blocked to such an extent that the ink droplets are not ejected from at least one of the nozzles 21 among the plurality of nozzles 21 communicating with the common liquid chamber 130 provided with the filter 40. That is, the state in which the filter hole 41 is blocked to such an extent that the ink droplets are not ejected from at least one nozzle 21 among the plurality of nozzles 21 includes not only the state in which all the plurality of filter holes 41 are blocked, but also the state in which at least one or more of the plurality of filter holes 41 among all the filter holes 41 are blocked. That is, when the pressure loss in the filter 40 is increased by a constant amount as compared with the pressure loss in a state in which all the filters 40 are not clogged, the ejection failure of the ink droplets from at least one nozzle 21 of the plurality of nozzles 21 occurs.

For example, when the threshold of the voltage change ΔE3 (the voltage change ΔE3 is a value smaller than the voltage change ΔE2, that is, ΔE3<ΔE2 is satisfied) calculated by the control section 4 based on the detection voltage E and the reference voltage E0 in a state in which at least one of the plurality of nozzles 21 cannot eject ink droplets due to the clogging of the filter 40 is set, the detection section 115 can predict that the ejection failure of the nozzles 21 due to the clogging of the filter 40 occurs. That is, when the voltage change ΔE calculated by the control section 4 based on the detection voltage E detected by the detection section 115 and the reference voltage E0 is ΔE1 or more and less than ΔE3, that is, when ΔE1≤ΔE<ΔE3 is satisfied, it is determined that the ink droplets are ejected from the nozzle 21 without any problem. In addition, when the voltage change ΔE is ΔE3 or more and less than ΔE2, that is, when ΔE3≤ΔE<E2 is satisfied, it is possible to predict that the ejection failure of the nozzle 21 will occur soon. When it is predicted that the nozzle 21 will have an ejection failure due to clogging of the filter 40 in this manner, the prediction result can be warned to the user by sound or screen. For example, a user who has received the warning can make a plan to perform, by himself/herself, so-called reverse cleaning of causing the cleaning liquid to flow back into the flow path to clean the foreign matter adhering to the filter 40, maintenance such as replacement of the filter 40, replacement of the liquid ejecting head 2 itself, or the like. In addition, the user who has received the warning can take measures such as making a plan to request the manufacturer of the liquid ejecting head 2 and the liquid ejecting apparatus 1 to perform maintenance or replacement of the liquid ejecting head 2. That is, by predicting the clogging state of the filter 40, it is possible to suppress the occurrence of the ejection failure of the ink droplets from the nozzle 21 at an unexpected timing such as during printing, and to perform the maintenance or replacement of the liquid ejecting head 2 in a planned manner.

In addition, when the voltage change ΔE is ΔE2 or more, that is, when ΔE2≤ΔE is satisfied, the ejection failure of the nozzle 21 has already occurred due to the clogging of the filter 40, and thus, the user can be warned of the immediate maintenance of the liquid ejecting head 2 or the immediate replacement of the liquid ejecting head 2 by sound or a screen. The user who has received the warning can immediately perform the maintenance or replacement of the liquid ejecting head 2, or can immediately request the manufacturer of the liquid ejecting head 2 and the liquid ejecting apparatus 1. Incidentally, when the liquid ejecting apparatus 1 includes the plurality of liquid ejecting heads 2, it is possible to extend the life of the liquid ejecting apparatus 1 at a low cost by specifying the liquid ejecting head 2 in which the filter 40 is clogged or is about to be clogged and replacing only the specified liquid ejecting head 2.

Since the liquid ejecting head 2 has individual differences, the reference voltage E0 and the voltage changes ΔE1, ΔE2, and ΔE3 change for each liquid ejecting head 2. Therefore, the reference voltage E0 or the voltage change ΔE1 when the suction cleaning is performed when the filter 40 is not clogged can be obtained as an experimental value by actually ejecting ink droplets before shipment of the liquid ejecting head 2 or immediately after shipment of the liquid ejecting head 2. In addition, the voltage change ΔE2 when the filter 40 is clogged and the voltage change ΔE3 which is the threshold can be obtained as theoretical values calculated by considering the pressure loss of the filter 40 with reference to the reference voltage E0 and the voltage change ΔE1. This is because, when the voltage changes ΔE2 and ΔE3 are detected by the experiment, it is necessary to actually clog the filter 40 before the liquid ejecting head 2 is shipped, and the liquid ejecting head 2 cannot be shipped as a product, and even when the filter 40 is cleaned, the quality as a product may be lowered. Incidentally, the reference voltage E0 and the voltage change ΔE1 may be obtained as theoretical values obtained by calculation considering the flow path resistance and the like.

In addition, the reference voltage E0 and the voltage changes ΔE1 to ΔE3, which are the above-described experimental values or theoretical values, are preferably stored in the storage element mounted on the liquid ejecting head 2, for example, the storage element built in the drive circuit 121 in the present embodiment, before the liquid ejecting head 2 is shipped. Of course, when the liquid ejecting head 2 is mounted with a storage element other than the drive circuit 121, the reference voltage and voltage change may be stored in the storage element. As described above, by storing the reference voltage E0 and the voltage changes ΔE1 to ΔE3, which have individual differences, of the liquid ejecting head 2 in the storage element of the liquid ejecting head 2, the clogging state of the filter 40 of the liquid ejecting head 2 can be detected by the detection section 115 with high accuracy. Of course, the reference voltage E0 and the voltage changes ΔE1 to ΔE3 may be stored in the storage element mounted on the liquid ejecting apparatus 1. In addition, the storage element that stores the reference voltage E0 and the voltage changes ΔE1 to ΔE3 may be accessible via a network by the liquid ejecting apparatus 1 or a computer coupled to the liquid ejecting apparatus 1. For example, a server device (not illustrated) that functions as a file server or a web server may be provided, and the server device may be coupled to the network. In this configuration, the storage included in the server device (not illustrated) may store the reference voltage E0 and the voltage changes ΔE1 to ΔE3 as the storage element. Further, the storage element may be realized as a cloud storage that is not limited to a specific server device.

In the present embodiment, the position of the compliance portion 119 when the suction cleaning is performed is detected by the detection section 115, but the present disclosure is not particularly limited to this. The detection section 115 may detect the position of the compliance portion 119 when the pressurization cleaning is performed.

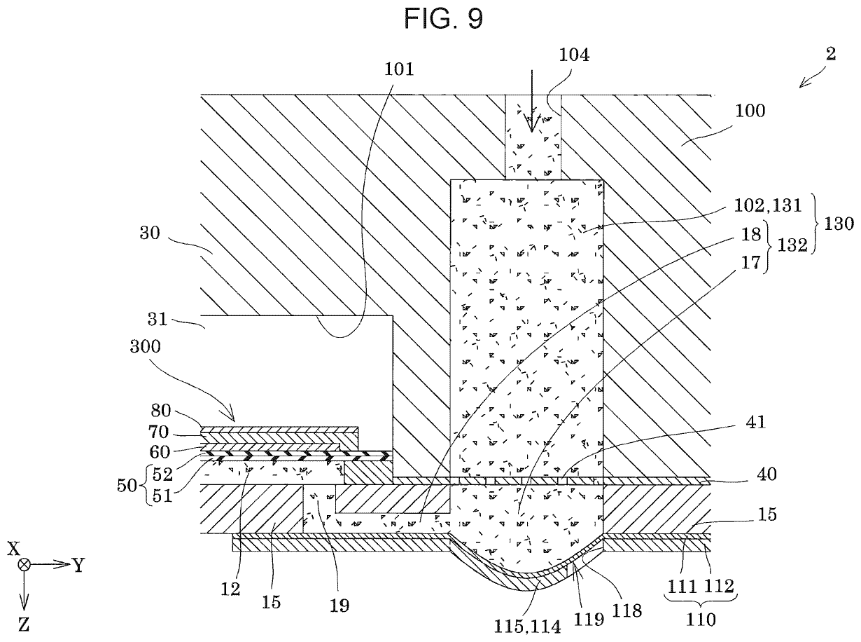

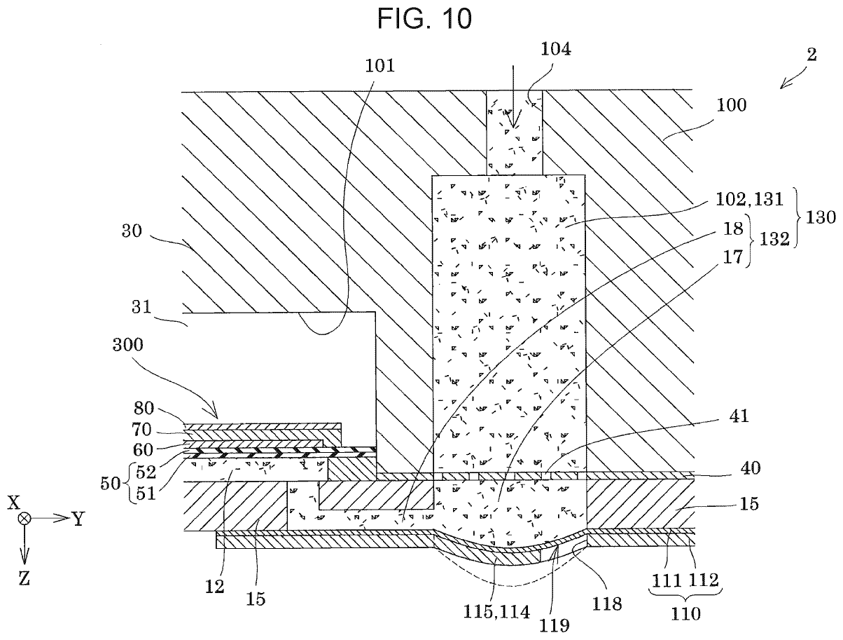

Here, a relationship between the clogging state of the filter 40 when the pressurization cleaning is performed and the deformation of the compliance portion 119 is illustrated in FIGS. 9 and 10. FIGS. 9 and 10 are sectional views of main portions illustrating the state of the liquid ejecting head 2.

When the pressurization cleaning is performed in a state in which the filter 40 is not clogged, as illustrated in FIG. 9, the ink is supplied from the upstream chamber 131 to the downstream chamber 132, and the pressure in the downstream chamber 132 is pressurized to become a positive pressure higher than the reference pressure. As a result, the compliance portion 119 is bent and deformed to be protrude in the +Z direction opposite to the downstream chamber 132. The control section 4 calculates the voltage change ΔE4 from the reference voltage E0 to the detection voltage E detected by the detection section 115 at this time.

In addition, when the pressurization cleaning is performed in a state in which the filter 40 is clogged, as illustrated in FIG. 10, the pressure loss due to the filter 40 becomes larger than in a state in which the filter 40 is not clogged, and the ink is difficult to be supplied from the upstream chamber 131 to the downstream chamber 132. Therefore, the pressure in the downstream chamber 132 is lower than that in FIG. 9. That is, the voltage change ΔE5 from the reference voltage E0 calculated by the control section 4 to the detection voltage E detected by the detection section 115 at this time is smaller than the voltage change ΔE4. The dotted line in FIG. 10 indicates the position of the compliance portion 119 in FIG. 9.

Then, when the threshold of the voltage change ΔE6 (the voltage change ΔE6 is a value larger than the voltage change ΔE5, that is, ΔE5<ΔE6) is set in a state in which at least one of the plurality of nozzles 21 cannot eject ink droplets due to clogging of the filter 40, the detection section 115 can predict that the ejection failure of the nozzle 21 occurs due to the clogging of the filter 40. That is, when the voltage change ΔE is larger than ΔE6, that is, when ΔE>ΔE6 is satisfied, it is determined that the ink droplets are ejected from the nozzle 21 without any problem. In addition, when the voltage change ΔE is ΔE6 or less and is larger than ΔE5, that is, when ΔE6≥ΔE>ΔE5 is satisfied, it is possible to predict that the ejection failure of the nozzle 21 will occur soon. When it is predicted that the nozzle 21 will have an ejection failure due to clogging of the filter 40 in this manner, the prediction result can be warned to the user by sound or screen. In addition, when the voltage change ΔE is ΔE5 or less, that is, when ΔE5≥ΔE is satisfied, the ejection failure of the nozzle 21 has already occurred due to the clogging of the filter 40. Therefore, the user can be warned by sound or screen of the immediate maintenance of the liquid ejecting head 2 or the immediate replacement of the liquid ejecting head 2.

By performing suction cleaning or pressurization cleaning in this manner and detecting the position of the compliance portion 119 by the detection section 115, the clogging state of the filter 40 can be detected. By the way, a configuration in which the detection section is provided in the filter 40 to detect the clogging state of the filter 40 according to the deformed position of the filter 40 is also conceivable, but it is necessary to provide the detection section in the common liquid chamber 130, and it is necessary to perform a highly waterproof treatment for protecting the detection section and the wire connected to the detection section from ink. In addition, when the detection section is provided in the filter 40, the detection section obstructs the flow of the ink in the common liquid chamber 130. In addition, a configuration in which the pressure sensor is disposed in the common liquid chamber 130 is also conceivable, but the volume of the common liquid chamber 130 is small, and it is substantially difficult to perform the configuration, and it is necessary to perform a highly waterproof treatment of the pressure sensor and the wire. In addition, there is a concern that the pressure sensor may obstruct the flow of the ink in the common liquid chamber 130. In the present embodiment, the detection section 115 is provided on the side opposite to the surface that defines the downstream chamber 132 of the flexible member 111 that is the compliance portion 119. Therefore, the ink is less likely to come into contact with the detection section 115, and thus, it is not necessary to perform an advanced waterproof treatment on the detection section 115, and it is possible to prevent the detection section 115 from obstructing the flow of the ink in the common liquid chamber 130.

In addition, the bending rigidity of the compliance portion 119 is smaller than the bending rigidity of the region of the filter 40 provided with the filter holes 41. Therefore, the compliance portion 119 has a larger amount of deformation based on the pressure change inside the downstream chamber 132 than the filter 40. Therefore, by providing the detection section 115 in the compliance portion 119, a position that is largely deformed can be detected as compared with a case where the detection section is provided in the filter 40, and the detection accuracy of the detection section 115 can be improved.

In the present embodiment, the detection section 115 is configured by a part of the frame member 112. Therefore, the number of components can be reduced and the cost can be reduced as compared with a case where the detection section 115 is provided with a member different from the frame member 112. In the present embodiment, a part of the wire of the detection section 115 is configured by the conductive portion 113a of a part of the frame member 112. In this way, even when a part of the wire of the detection section 115 is configured by a part of the frame member 112, the number of components can be reduced and the cost can be reduced as compared with a case where the wire of the detection section 115 is provided by a separate member from the frame member 112.

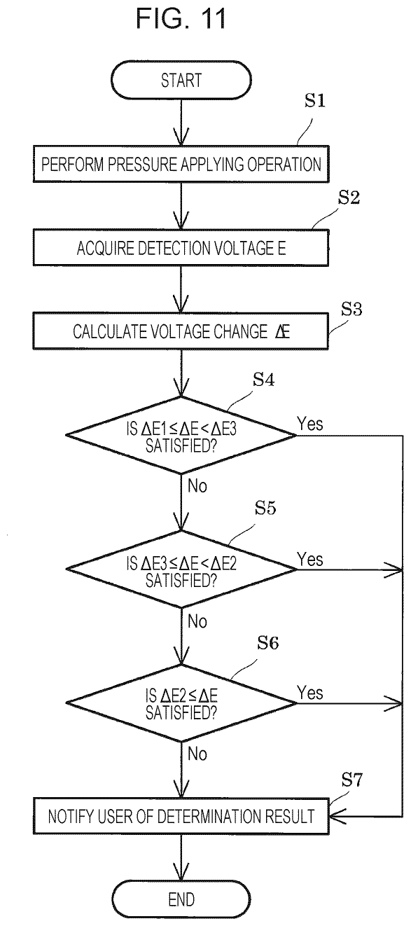

Here, a method of detecting the state of the liquid ejecting head 2 will be described with reference to FIG. 11. FIG. 11 is a flowchart illustrating a method of detecting the state of the liquid ejecting head 2.

First, in Step S1, a pressure applying operation of applying pressure from the outside of the liquid ejecting head 2 into the common liquid chamber 130 is performed.

Next, in Step S2, the detection voltage E corresponding to the position of the compliance portion 119 detected by the detection section 115 is acquired while a pressure applying operation of applying the pressure from the outside of the liquid ejecting head 2 into the common liquid chamber 130 is performed. The detection voltage E is an example of “second information regarding the position of the flexible member detected by the detection section while the pressure applying operation is performed”. Here, the pressure applying operation includes a depressurization operation of decompressing the inside of the common liquid chamber 130 by the suction cleaning as described above, and a pressurization operation of pressurizing the inside of the common liquid chamber 130 by the pressurization cleaning. That is, the pressure to be applied in the pressure applying operation to the common liquid chamber 130 includes pressurization and depressurization. For example, the pressurization includes pressurizing the ink in the common liquid chamber 130 to a positive pressure with respect to the outside pressure, and the depressurization includes depressurizing the ink in the common liquid chamber 130 to a negative pressure with respect to the outside pressure. Of course, in the pressurization and depressurization, pressurization and depressurization may be performed based on the pressure in the common liquid chamber 130 before the pressurization or depressurization, regardless of the outside pressure. In the present embodiment, the inside of the common liquid chamber 130 is depressurized by suction cleaning to make the inside of the common liquid chamber 130 negative pressure.

Next, in Step S3, the control section 4 calculates the voltage change ΔE based on the reference voltage E0 and the detection voltage E detected in Step S2.

Next, in Step S4, it is determined whether or not the voltage change ΔE calculated in Step S3 satisfies ΔE1≤ΔE<ΔE3. When the voltage change ΔE satisfies ΔE1≤ΔE<ΔE3 (Step S4: Yes), it is determined that the filter 40 is not clogged, and the process proceeds to Step S7. When the condition is not satisfied (Step S4: No), the process proceeds to Step S5. In Step S5, it is determined whether or not the voltage change ΔE satisfies ΔE3≤ΔE<ΔE2. When the voltage change ΔE satisfies ΔE3≤ΔE<ΔE2 (Step S5: Yes), it is determined that the filter 40 is clogged to such an extent that the ejection failure of the nozzles 21 will occur soon, and the process proceeds to Step S7. When the condition is not satisfied (Step S5: No), the process proceeds to Step S6. In Step S6, it is determined whether or not the voltage change ΔE satisfies ΔE2≤ΔE . When the condition is satisfied (Step S6: Yes), it is determined that the clogging has already occurred in the filter 40 to such an extent that the ejection failure of the nozzle 21 has occurred, and the process proceeds to Step S7. When the condition is not satisfied (Step S6: No), it is determined that the detection section 115 has a problem, and the process proceeds to Step S7. In Step S5, when ΔE3≤ΔE<ΔE2 is not satisfied, it is determined that ΔE2≤ΔE is satisfied, and thus, Step S6 may be omitted.

That is, in Steps S4 to S6, three types of determination are performed based on the voltage change ΔE , that is, whether or not the filter 40 is clogged, whether or not the filter 40 is clogged to the extent that the ejection failure of the nozzle 21 is about to occur, and whether or not the filter 40 is clogged to the extent that the ejection failure of the nozzle 21 has already occurred.

Thereafter, in Step S7, the determination results in Steps S4 to S6 are notified to the user who is the user of the liquid ejecting apparatus 1 by sound, screen display, or the like. The user makes a plan for performing the maintenance or replacement of the liquid ejecting head 2 based on the notification content, or immediately performs the maintenance or replacement.

### Second Embodiment

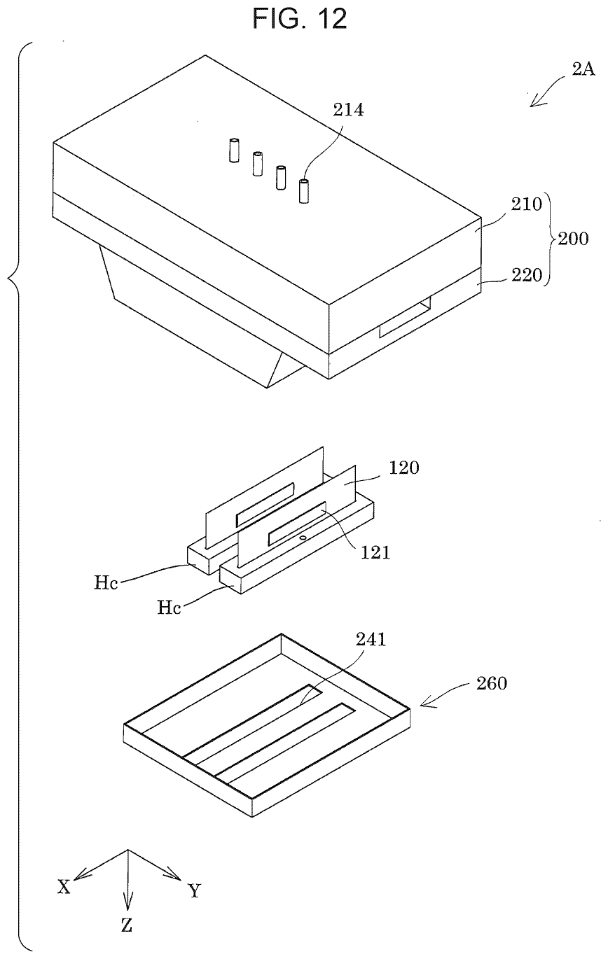

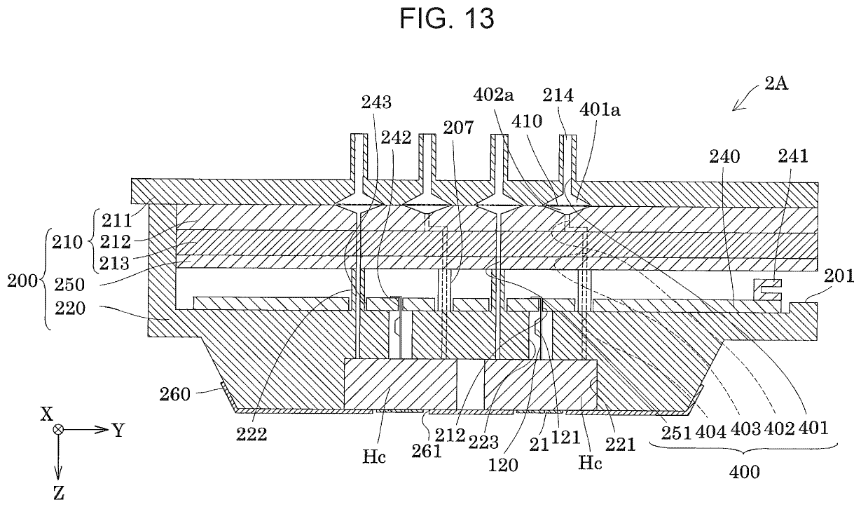

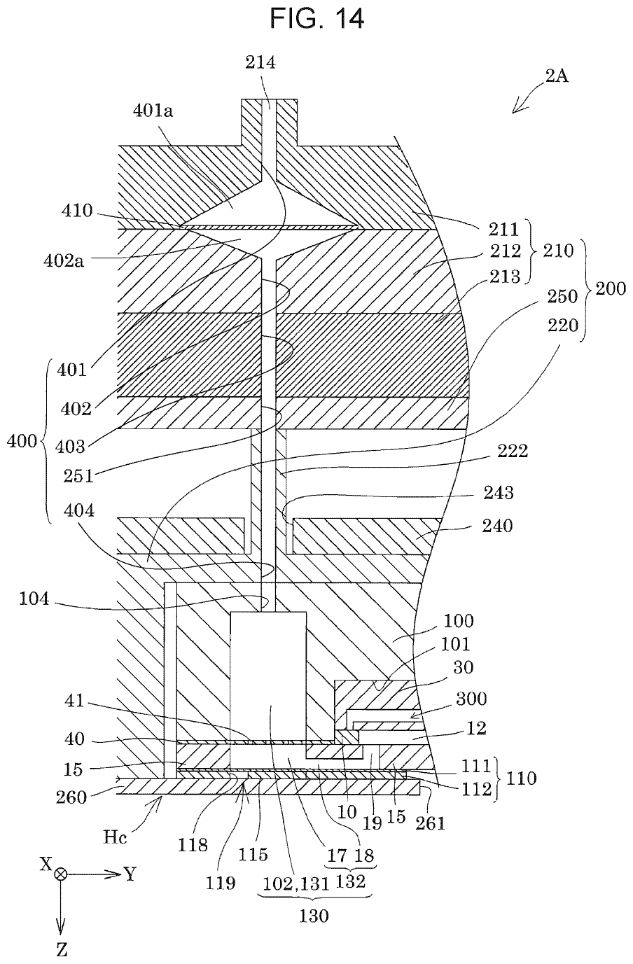

FIG. 12 is an exploded perspective view of a liquid ejecting head 2A according to a second embodiment of the present disclosure. FIG. 13 is a sectional view of the liquid ejecting head 2A according to a second embodiment. FIG. 14 is an enlarged view of the main portion of FIG. 13. Each direction of the liquid ejecting head 2A will be described based on the directions when the liquid ejecting head 2A is mounted on the liquid ejecting apparatus 1 illustrated in FIG. 1, that is, the X-axis direction, the Y-axis direction, and the Z-axis direction. The same reference signs will be given to the same members as those in the above-described embodiment, and the repetitive description thereof will be omitted.

As illustrated in the drawings, the liquid ejecting head 2A includes a plurality of head chips Hc, in the present embodiment, two head chips Hc, a flow path unit 200 having a flow path 400, a relay substrate 240, and a cover 260.

The head chip Hc of the present embodiment corresponds to the liquid ejecting head 2 of the first embodiment described above. That is, each head chip Hc has a plurality of nozzles 21, the common liquid chamber 130, the filter 40, the compliance substrate 110, and the detection section 115 (refer to FIG. 5).

The flow path unit 200 supplies the ink from the liquid storage portion 3 to the head chip Hc. The flow path unit 200 includes a first flow path unit 210, a second flow path unit 220, and a seal member 250.

In the first flow path unit 210, the first flow path member 211, the second flow path member 212, and the third flow path member 213 are laminated in this order in the +Z direction.

The first flow path member 211 has a first coupling portion 214 coupled to the liquid storage portion 3 in which the ink is stored. In the present embodiment, the first coupling portion 214 is provided to protrude in the −Z direction in a tubular shape on a surface of the first flow path member 211 facing the −Z direction. The liquid storage portion 3 may be directly coupled to the first coupling portion 214 or may be coupled via a supply pipe or the like such as a tube. The inside of the first coupling portion 214 is provided with a first flow path 401 to which the liquid from the liquid storage portion 3 is supplied. A first liquid reservoir portion 401a having a wider inner diameter than other regions is provided at the end portion of the first flow path 401 in the +Z direction.

The second flow path member 212 includes the second flow path 402 communicating with the first flow path 401. The second flow path 402 has a portion formed along the Z-axis direction and a portion formed along a direction orthogonal to the Z-axis direction. A second liquid reservoir portion 402a having a wider inner diameter than other regions is provided at the end portion of the second flow path 402 in the −Z direction. The upstream filter 410 is disposed at a laminated interface between the first flow path member 211 and the second flow path member 212 so as to separate the first liquid reservoir portion 401a and the second liquid reservoir portion 402a. The upstream filter 410 captures foreign matters such as dust and air bubbles contained in the ink. The upstream filter 410 is, for example, a filter having a coarser mesh than the filter 40.

The third flow path member 213 includes the third flow path 403 communicating with the second flow path 402. The third flow path 403 is provided along the Z-axis direction.

The other end of the third flow path 403 is opened on a surface of the third flow path member 213 facing the +Z direction, and is coupled to the fourth flow path 404 of the second flow path unit 220 via the seal member 250 in a liquid-tight state. The seal member 250 is formed of an elastic member such as rubber, and the seal member 250 is provided with a flow path communication passage 251 penetrating in the Z-axis direction. The third flow path 403 and the fourth flow path 404 communicate with each other via a flow path communication passage 251.

The second flow path unit 220 holds the plurality of head chips Hc on a surface facing the +Z direction. Specifically, the second flow path unit 220 has an accommodation portion 221 having a recessed shape that is open on a surface facing the +Z direction. The head chip Hc is accommodated in the accommodation portion 221. A plurality of head chips Hc, in the present embodiment, two head chips Hc as an example are held in the liquid ejecting head 2A of the present embodiment. In the present embodiment, the two head chips Hc are arranged side by side in the Y-axis direction to be located at the same position in the X-axis direction. In the present embodiment, the surface of the head chip Hc facing the −Z direction and the bottom surface of the accommodation portion 221, that is, the surface facing the +Z direction are bonded to each other by an adhesive (not illustrated).

In the present embodiment, a configuration in which one accommodation portion 221 is provided in common to all the head chips Hc is described, but the present disclosure is not particularly limited thereto. For example, the accommodation portion 221 may be provided independently for each head chip Hc.

The second flow path unit 220 has a tubular second coupling portion 222 protruding in the −Z direction on a surface facing the −Z direction. The inside of the second coupling portion 222 is provided with a fourth flow path 404 to which the ink is supplied from the third flow path 403 of the first flow path unit 210. The fourth flow path 404 is provided along the Z-axis direction. Of course, the second flow path unit 220 may be configured with two or more members laminated in the Z-axis direction, and the fourth flow path 404 may be routed along the XY plane. One end of the fourth flow path 404 is opened on the bottom surface of the accommodation portion 221 and is coupled to the introduction port 104 of the head chip Hc.

In addition, the second flow path unit 220 is provided with a wiring insertion hole 223 for inserting the wiring member 120 of each head chip Hc. In the present embodiment, one wiring insertion hole 223 is provided for each head chip Hc. The wiring member 120 of the head chip Hc is led out to the surface side of the second flow path unit 220 facing the −Z direction via the wiring insertion hole 223.

In the Z-axis direction, the relay substrate 240 to which the wiring members 120 of the plurality of head chips Hc are commonly coupled is provided between the second flow path unit 220 and the seal member 250. The relay substrate 240 is made of a hard rigid substrate having no flexibility, and wire, electronic components, and the like illustrated are mounted thereon. In the present embodiment, a connector 241 to which an external wire (not illustrated) provided outside the liquid ejecting head 2A is coupled is illustrated as an example of the electronic component. A printing signal and the like for controlling the head chip Hc are input to the relay substrate 240 from the external wire via the connector 241, and is supplied from the relay substrate 240 to each head chip Hc. An external wiring opening portion 201 for inserting an external wire coupled to the connector 241 is provided on the side wall of the flow path unit 200 facing the connector 241. The external wire is coupled to the connector 241 of a relay substrate 240 provided inside the flow path unit 200 via the external wiring opening portion 201.

In addition, the relay substrate 240 has a through-hole 242 for leading the wiring member 120 of the head chip Hc to the surface side facing the −Z direction. One through-hole 242 is provided for each head chip Hc, and a total of two through-holes 242 are provided.

In addition, the relay substrate 240 is provided with a coupling portion insertion hole 243 provided to penetrate the relay substrate 240 in the Z-axis direction. The second coupling portion 222 of the second flow path unit 220 is inserted through the coupling portion insertion hole 243 to the −Z direction side of the relay substrate 240, and is coupled to the third flow path 403 of the first flow path unit 210 via the flow path communication passage 251 of the seal member 250.

The cover 260 is fixed to the surface of the second flow path unit 220 facing the +Z direction. The cover 260 is made of a metal plate such as stainless steel, and has a size that closes the opening of the accommodation portion 221 of the second flow path unit 220. The cover 260 is a common member that is fixed to the frame member 112 of the compliance substrate 110, that is, a surface of the two head chips Hc facing the +Z direction. The compliance substrate 110 and the cover 260 can be fixed by an insulating adhesive, and thus it is possible to suppress the conductive portion 113a from being short-circuited by the cover 260. The cover 260 covers the opening portion 118 of the frame member 112, and thus, a surface of the cover 260 facing the −Z direction defines a compliance space together with the frame member 112 and the flexible member 111. In addition, the cover 260 is provided with an exposure opening portion 261 that exposes the nozzle 21 of the head chip Hc in the +Z direction. The exposure opening portion 261 is provided independently for each head chip Hc. The ink is ejected from the nozzle 21 exposed from the exposure opening portion 261 as ink droplets in the +Z direction.

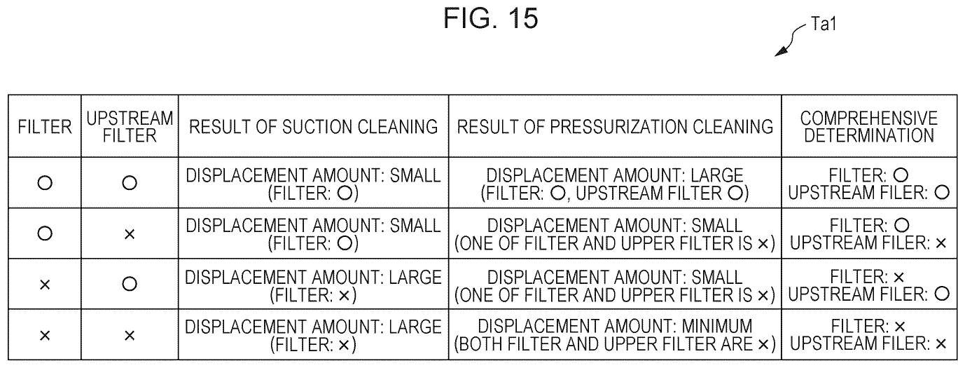

In such a liquid ejecting head 2A, the position of the compliance portion 119 during each of the suction cleaning and the pressurization cleaning is detected by the detection section 115, and the clogging state of each of the filter 40 and the upstream filter 410 can be estimated by combining these results. A method of determining the state of the liquid ejecting head 2A is illustrated in Table Ta1 of FIG. 15. In addition, a circle in the filter member and the upstream filter in Table Ta1 indicates that the filter member and the upstream filter are not actually clogged, and a cross indicates that the filter member and the upstream filter are actually clogged. In addition, Table Ta1 illustrates the results of the suction cleaning and the pressurization cleaning as the magnitude of the displacement amount of the compliance portion 119 and the states of the filter 40 and the upstream filter 410 estimated from the results. Table Ta1 illustrates the comprehensive determination in which the estimated state is combined.

As illustrated in Table Ta1, when the filter 40 is not clogged when the suction cleaning is performed, the compliance portion 119 is deformed to be small, and thus the voltage change ΔE satisfies ΔE1≤ΔE<ΔE3. Meanwhile, when the filter 40 is clogged during the suction cleaning, the compliance portion 119 is largely deformed as compared with a case where the clogging does not occur, and thus the voltage change ΔE satisfies ΔE2≤ΔE .

Further, when clogging occurs in either the filter 40 or the upstream filter 410 during the pressurization cleaning, the compliance portion 119 is deformed to be small, and thus the voltage change ΔE satisfies ΔE5>ΔE . In addition, when clogging occurs in both the filter 40 and the upstream filter 410 during the pressurization cleaning, the compliance portion 119 deforms to a minimum, and thus the voltage change ΔE satisfies ΔE7≥ΔE . Here, the voltage change ΔE7 corresponds to the voltage change calculated based on the detection voltage E of the detection section 115 when the pressurization cleaning is performed in a state in which both the filter 40 and the upstream filter 410 are clogged, is a threshold smaller than ΔE5, and can be calculated as a theoretical value considering the flow path resistance of the filter 40 and the upstream filter 410.

In addition, when clogging does not occur in both the filter 40 and the upstream filter 410 during the pressurization cleaning, the compliance portion 119 is largely deformed, and thus the voltage change ΔE satisfies ΔE>ΔE6.

Therefore, as illustrated in Table Ta1, by combining the results of the suction cleaning and the pressurization cleaning, both the clogging state of the filter 40 and the clogging state of the upstream filter 410 can be detected.

That is, in the state detection method of the liquid ejecting head 2A described above, the “second information” includes both the information detected while the suction cleaning is being performed and the information detected while the pressurization cleaning is being performed.

Further, when the liquid ejecting head 2A has the plurality of head chips Hc as in the present embodiment, the life of the liquid ejecting head 2A can be extended at a low cost by specifying the head chip Hc in which the filter 40 is clogged and replacing only the specified head chip Hc. The cross in Table Ta1 may indicate that the filter member and the upstream filter are about to be clogged, and in this case, the threshold used for determining the clogged state may be changed.

### Third Embodiment

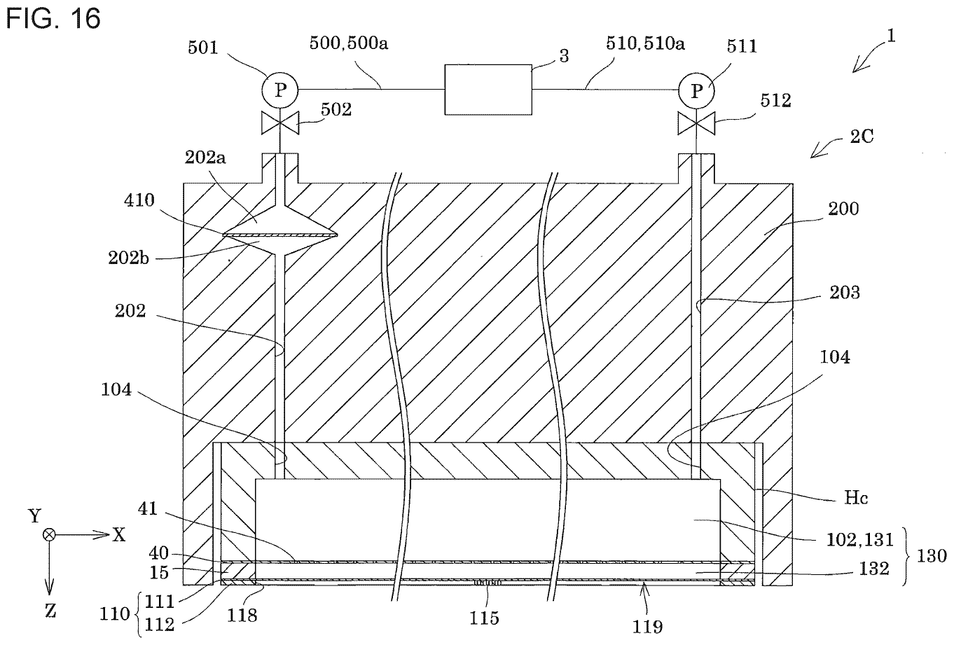

FIG. 16 is a view illustrating a schematic configuration of a liquid ejecting apparatus 1 according to a third embodiment of the present disclosure. The same reference signs will be given to the same members as those in the above-described embodiment, and the repetitive description thereof will be omitted.

As illustrated in FIG. 16, a liquid ejecting head 2C includes a head chip Hc and a flow path unit 200. In addition, although not particularly illustrated, the liquid ejecting head 2C includes a relay substrate 240, a cover 260, and the like, similarly to the above-described second embodiment. The number of head chips Hc included in the liquid ejecting head 2C is not particularly limited, and may be one or two or more.

The head chip Hc corresponds to the liquid ejecting head 2 of the first embodiment described above. That is, each head chip Hc has a plurality of nozzles 21, a common liquid chamber 130, a filter 40, a compliance substrate 110, and a detection section 115.

The flow path unit 200 includes a supply flow path 202 for supplying the ink in the liquid storage portion 3 to the head chip Hc, and a collection flow path 203 for collecting the ink from the head chip Hc to the liquid storage portion 3. The supply flow path 202 and the collection flow path 203 communicate with an ink introduction portion 102 of the head chip Hc, respectively. That is, the head chip Hc has one introduction port 104 at each of both end portions of the ink introduction portion 102 in the X-axis direction, and has a total of two introduction ports 104. In the present embodiment, the supply flow path 202 communicates with the introduction port 104 on one end side of the ink introduction portion 102 in the X-axis direction, and the collection flow path 203 communicates with the introduction port 104 on the other end side of the ink introduction portion 102 in the X-axis direction. As a result, the ink supplied from the supply flow path 202 to the ink introduction portion 102 flows in the ink introduction portion 102 in the X-axis direction and is collected from the collection flow path 203.

The upstream filter 410 is provided in the middle of the supply flow path 202 in the same manner as in the second embodiment described above. Specifically, in the middle of the supply flow path 202, the supply flow path 202 includes an upstream first liquid reservoir portion 202a widened more than other regions and an upstream second liquid reservoir portion 202b, and the upstream filter 410 is disposed to separate the upstream first liquid reservoir portion 202a and the upstream second liquid reservoir portion 202b.

The liquid ejecting apparatus 1 includes a first external flow path member 500 having a first introduction path 500a that couples the liquid storage portion 3 and the supply flow path 202 of the liquid ejecting head 2C, and a second external flow path member 510 having a second external flow path 510a that couples the liquid storage portion 3 and the collection flow path 203 of the liquid ejecting head 2C. The first external flow path member 500 and the second external flow path member 510 are tubular members such as tubes provided with flow paths inside.

A first pressure-feeding unit 501 that pressure-feeds the ink in the liquid storage portion 3 toward the liquid ejecting head 2C and a first valve 502 that opens and closes the first introduction path 500a are provided in the middle of the first introduction path 500a. The first pressure-feeding unit 501 is configured by, for example, a pressurizing pump. The first valve 502 is disposed between the first pressure-feeding unit 501 and the liquid ejecting head 2C, and opens and closes the first introduction path 500a.

A second pressure-feeding unit 511 that pressure-feeds the ink in the liquid storage portion 3 toward the liquid ejecting head 2C and a second valve 512 that opens and closes the second external flow path 510a are provided In the middle of the second external flow path 510a. The second pressure-feeding unit 511 is configured by, for example, a pressurizing pump. The second valve 512 is disposed between the second pressure-feeding unit 511 and the liquid ejecting head 2C, and opens and closes the second external flow path 510a.

In such a liquid ejecting apparatus 1, the ink from the liquid storage portion 3 is supplied to the liquid ejecting head 2C via the first introduction path 500a by the first pressure-feeding unit 501. The ink among the ink supplied to the ink introduction portion 102 and the common liquid chamber 130 of the liquid ejecting head 2C, which is not consumed by the liquid ejecting head 2C, is collected in the liquid storage portion 3 via the second external flow path 510a. As a result, the ink is circulated between the liquid storage portion 3 and the liquid ejecting head 2C.

Further, the pressurization cleaning can be performed by closing the second external flow path 510a by the second valve 512. That is, by closing the second external flow path 510a by the second valve 512, the ink pressurized and supplied from the liquid storage portion 3 to the liquid ejecting head 2C by the first pressure-feeding unit 501 is discharged from the nozzle 21 without being discharged from the collection flow path 203. In the present embodiment, the pressurization cleaning for pressurization-supplying the ink from the supply flow path 202 and discharging the ink from the nozzle 21 is referred to as a first pressurization cleaning.

Further, by providing the second pressure-feeding unit 511, the ink in the liquid storage portion 3 can be pressurized and supplied with the ink from the collection flow path 203 side of the liquid ejecting head 2C. At this time, by closing the first introduction path 500a by the first valve 502, the ink pressurized and supplied from the liquid storage portion 3 to the liquid ejecting head 2C by the second pressure-feeding unit 511 is discharged from the nozzle 21 without being discharged from the supply flow path 202. That is, the ink pressurized and supplied from the collection flow path 203 side is discharged from the nozzle 21 without passing through the upstream filter 410. In the present embodiment, the pressurization cleaning in which the ink is pressurized and supplied from the collection flow path 203 and discharged from the nozzle 21 is referred to as the second pressurization cleaning.

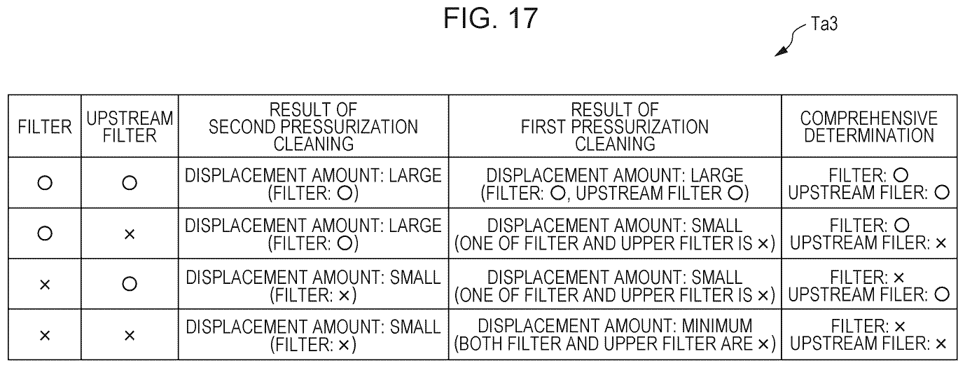

Then, the position of the compliance portion 119 during each of the first pressurization cleaning and the second pressurization cleaning is detected by the detection section 115, and the results are combined to estimate the clogging state of each of the filter 40 and the upstream filter 410. A method of detecting the state of the liquid ejecting head 2C is illustrated in Table Ta3 of FIG. 17. Since the notation of Table Ta3 is the same as that of Table Ta1 described above, the repetitive description will be omitted.

As illustrated in Table Ta3, since the second pressurization cleaning is performed without the ink passing through the upstream filter 410, the clogging state of the filter 40 can be detected by the second pressurization cleaning. That is, when the filter 40 is not clogged during the second pressurization cleaning, the compliance portion 119 is largely deformed, and thus the voltage change ΔE satisfies ΔE5<ΔE≤ΔE4.

Meanwhile, when the filter 40 is clogged during the second pressurization cleaning, the compliance portion 119 is deformed to be smaller than that when the filter 40 is not clogged, and thus the voltage change ΔE satisfies ΔE5≥ΔE.

In the first pressurization cleaning, the ink passes through the upstream filter 410 and the filter 40. Therefore, it is not possible to determine whether any of the filter 40 and the upstream filter 410 is clogged only by the result of the first pressurization cleaning. That is, when clogging does not occur in both the upstream filter 410 and the filter 40 during the first pressurization cleaning, the compliance portion 119 is largely deformed, and thus the voltage change ΔE satisfies ΔE5<ΔE≤ΔE4. Meanwhile, when clogging occurs in either the filter 40 or the upstream filter 410 during the first pressurization cleaning, the compliance portion 119 is deformed to be smaller than when clogging does not occur in both the filter 40 and the upstream filter 410, and thus, the voltage change ΔE has a smaller value than when clogging does not occur in both the filter 40 and the upstream filter 410. In addition, when clogging occurs in both the filter 40 and the upstream filter 410 during the first pressurization cleaning, the compliance portion 119 is further deformed to be smaller than when clogging occurs in either the filter 40 or the upstream filter 410, and thus, the voltage change ΔE has a smaller value than when clogging occurs in either filter 40 or the upstream filter 410.

Therefore, as illustrated in Table Ta3, by combining the results of each of the first pressurization cleaning and the second pressurization cleaning, both the clogging state of the filter 40 and the clogging state of the upstream filter 410 can be detected.

That is, in the state detection method of the liquid ejecting head 2C described above, the “second information” includes both the information detected during the suction cleaning and the information detected during the pressurization cleaning.

The first pressurization cleaning of the present embodiment is an example of the “first pressurization operation”, and the second pressurization cleaning is an example of the “second pressurization operation”.

### Fourth Embodiment

In the above-described the first embodiment, the voltage value detected by the detection section 115 in the standby state is used as the reference voltage E0. However, the present embodiment is different from the first embodiment in that the voltage value detected by the detection section 115 in a state different from that of the first embodiment is used as the reference voltage.

Specifically, the degree of clogging of the filter 40 is estimated based on third information regarding the position of the compliance portion 119 detected by the detection section 115 during the pressure applying operation of applying the pressure inside the common liquid chamber 130 at a first timing when the filter 40 is not clogged, and fourth information regarding the position of the compliance portion 119 detected by the detection section 115 during the pressure applying operation at a second timing later than the first timing.

First, a case where the pressure applying operation is the suction cleaning will be described. At the first timing when the filter 40 is not clogged, the control section 4 stores, in a storage element (not illustrated), a detection voltage e corresponding to the position of the compliance portion 119 detected by the detection section 115 while the negative pressure is acting in the common liquid chamber 130 by the suction cleaning. The detection voltage e corresponding to the position of the compliance portion 119 detected by the detection section 115 while the suction cleaning is performed at the first timing is a reference voltage el in the present embodiment, and is an example of “third information”. The reference voltage el can be obtained as an experimental value by actually ejecting ink droplets at the first timing at which clogging does not occur in the filter 40, such as before or immediately after shipment of the liquid ejecting head 2, or immediately after making the filter 40 reusable by cleaning the filter 40 of the liquid ejecting head 2.

Then, at the second timing after the liquid ejecting head 2 is used in the printing operation for a predetermined period, the detection section 115 detects a detection voltage eS corresponding to the position of the compliance portion 119 while the negative pressure is acting in the common liquid chamber 130 by the suction cleaning, and transmits the detection voltage eS to the control section 4. The detection voltage eS corresponding to the position of the compliance portion 119 detected by the detection section 115 while the suction cleaning is performed at the second timing is an example of “fourth information”.

The second timing may be any timing after the first timing, for example, two weeks after the first timing or one month after the first timing. In addition, the detection operation of the detection voltage e at the second timing may be provided a plurality of times at predetermined intervals after the first timing.

The control section 4 calculates a voltage change δeS, which is the absolute value of the difference between the reference voltage e1 and the detection voltage eS. The control section 4 calculates the voltage changes δe1 and δe2 as the thresholds based on the theoretical values considering the flow path resistance of the filter 40 and the like, and stores the calculated values in a storage portion (not illustrated). The voltage change δe1 corresponds to the absolute value of the difference between the detection voltage e and the reference voltage e1 detected by the detection section 115 when the suction cleaning is performed in a state in which the filter 40 is clogged, and the voltage change δe2 corresponds to the absolute value of the difference between the detection voltage e and the reference voltage e1 detected by the detection section 115 while the suction cleaning is performed in a state in which the ink droplets cannot be ejected from at least one of the plurality of nozzles 21 due to the clogging of the filter 40. That is, the threshold δe1>the threshold δe2 is satisfied. Then, the control section 4 determines that the filter 40 is not clogged when δe2 >δeS is satisfied for the calculated voltage change δeS, determines that the filter 40 is clogged to a degree that the ejection failure of the nozzle 21 is about to occur when δe1>δeS≥δe2 is satisfied, and determines that the filter 40 is already clogged to a degree that the ejection failure of the nozzle 21 occurs when δeS≥del is satisfied.

Next, a case where the pressure applying operation is the pressurization cleaning will be described. The description will be omitted for the same points as in the case where the pressure applying operation is the suction cleaning. At the first timing when the filter 40 is not clogged, the control section 4 stores the detection voltage e corresponding to the position of the compliance portion 119 detected by the detection section 115 while the positive pressure is applied in inside of the common liquid chamber 130 by the pressurization cleaning, in a storage element (not illustrated). The detection voltage e corresponding to the position of the compliance portion 119 detected by the detection section 115 while the pressurization cleaning is performed at the first timing is the reference voltage e2 in the present embodiment, and is an example of “third information”.

At the second timing, the detection voltage eP corresponding to the position of the compliance portion 119 detected by the detection section 115 while the positive pressure is applied in the common liquid chamber 130 by the pressurization cleaning is transmitted to the control section 4. The detection voltage eP corresponding to the position of the compliance portion 119 detected by the detection section 115 while the pressurization cleaning is performed at the second timing is an example of “fourth information”.

The control section 4 calculates the voltage change δeS, which is the absolute value of the difference between the reference voltage e2 and the detection voltage eP. The control section 4 calculates the voltage changes δe3 and δe4 as the thresholds, as theoretical values considering the flow path resistance of the filter 40, and stores the calculated values in a storage portion (not illustrated). The voltage change δe3 corresponds to the absolute value of the difference between the detection voltage e detected by the detection section 115 and the reference voltage e2 when the pressurization cleaning is performed in a state in which the filter is clogged, and the voltage change δe4 corresponds to the absolute value of the difference between the detection voltage e and the reference voltage e2 detected while the pressurization cleaning is being performed in a state in which at least one of the plurality of nozzles 21 is about to be unable to eject ink droplets due to the clogging of the filter 40. That is, the threshold δe3>the threshold δe4 is satisfied. Then, the control section 4 determines that the filter 40 is not clogged when δe4>δeP is satisfied for the calculated voltage change δeP, determines that the filter 40 is clogged to a degree that the ejection failure of the nozzle 21 is about to occur when δe3>δeS≥δe4 is satisfied, and determines that the filter 40 is already clogged to a degree that the ejection failure of the nozzle 21 occurs when δeS≥δe3 is satisfied. As described above, the same effect as that of the first embodiment can be obtained in the present embodiment.

### Other Embodiments

Although each embodiment of the present disclosure was described above, the basic configuration of the present disclosure is not limited to the above-described one.

For example, in each of the above-described embodiments, the detection section 115 is provided by the beam portion 114 of a part of the frame member 112, but the present disclosure is not particularly limited thereto. For example, the detection section 115, which is a member different from the frame member 112, may be attached to the flexible member 111. When the detection section 115 is configured with a member different from the frame member 112, a part of the outer peripheral frame portion 113, that is, the conductive portion 113a and the non-conductive portion 113b may be used as the wire of the detection section 115, and the other wires may be separately provided. However, as in each of the above-described embodiments, the detection section 115 is provided by the beam portion 114 of the frame member 112, and a part of the outer peripheral frame portion 113 is used as the wire of the detection section 115, so that the number of components can be reduced and the cost can be reduced.

In addition, in each of the above-described embodiments, the strain gauge is used as the detection section 115, but the present disclosure is not particularly limited thereto. For example, a piezoelectric element may be used as the detection section 115. That is, the position of the compliance portion 119 may be detected by attaching the piezoelectric element to the surface of the compliance portion 119 facing the opposite side of the common liquid chamber 130 and detecting the magnitude of the voltage change generated in the piezoelectric element in response to the deformation of the compliance portion 119.

In addition, in each of the above-described embodiments, the detection section 115 is provided on the surface of the compliance portion 119 facing the opposite side of the common liquid chamber 130, but the present disclosure is not particularly limited thereto. As the detection section, for example, a non-contact sensor such as an ultrasonic sensor or a laser range finder that can detect the position of the compliance portion 119 in a non-contact manner with the compliance portion 119 may be used. That is, the fact that “the detection section is disposed on the side opposite to the surface that defines the downstream chamber of the flexible member” includes the case where the detection section is disposed in contact with the surface that defines the downstream chamber of the flexible member and the case where the detection section is disposed at a position separated from the surface that defines the downstream chamber of the flexible member without coming into contact with the surface.

In addition, in each of the above-described embodiments, the method of detecting clogging of the filter 40 by detecting the position of the compliance portion 119 by the detection section 115 is described, but the present disclosure is not limited thereto. For example, the ink from the nozzle 21 or the ink from the upstream may enter the opening portion 118 and adhere to the compliance portion 119, and the compliance portion 119 may be pushed up to the common liquid chamber 130 side, that is, to be convex in the −Z direction by the adhered ink. In such a state, the performance of the compliance portion 119 is lowered, and the compliance portion 119 may not be able to absorb the pressure fluctuation of the downstream chamber 132, and there is a possibility that a problem such as ejection failure of ink droplets from the nozzle 21 may occur. According to the detection section 115 of the present embodiment, by detecting the position of the compliance portion 119, it is also possible to detect a problem caused by the ink adhering to the compliance portion 119.

In addition, in each of the above-described embodiments, the thin film type piezoelectric actuator 300 is described as the drive element that causes the pressure change in the pressure chamber 12, but the drive element is not particularly limited thereto, and may be, for example, a heat generating element.

Furthermore, the present disclosure is intended for a liquid ejecting head in general. Examples of the liquid ejecting head include recording heads such as various ink jet recording heads used in an image recording apparatus such as a printer, and coloring material ejecting heads used for manufacturing color filters in liquid crystal displays and the like. Examples of the liquid ejecting head include an electrode material ejecting head used for forming an electrode in an organic EL display, a field emission display (FED), and the like, and a bioorganic substance ejecting head used for manufacturing a biochip. The present disclosure can also be applied to a liquid ejecting apparatus including the liquid ejecting head.

### Supplementary Notes

From the embodiments exemplified above, for example, the following configuration can be ascertained.

According to Aspect 1 as a preferred aspect, a liquid ejecting head includes a plurality of nozzles that eject a liquid, a common liquid chamber that communicates with the plurality of nozzles, a filter that partitions the common liquid chamber into an upstream chamber and a downstream chamber, a flexible member that defines the downstream chamber of the common liquid chamber, and a detection section that is disposed on a side opposite to a surface of the flexible member that defines the downstream chamber and detects a position of the flexible member.

Accordingly, the degree of clogging of the filter in the common liquid chamber can be detected by the detection section. Therefore, it is possible to calculate the cleaning time or the replacement time of the filter based on the filter life of the liquid ejecting head. Further, since the detection section is not disposed in the flow path, it is not necessary to perform strict waterproof treatment, and it is possible to suppress the detection section from obstructing the flow of the liquid in the flow path.

In Aspect 2 which is a specific example of Aspect 1, the detection section is disposed at a central portion of the flexible member in the longitudinal direction of the common liquid chamber. Accordingly, by disposing the detection section at the central portion of the flexible member having a large amount of displacement, the detection accuracy can be improved.

In Aspect 3 which is a specific example of Aspect 1, the detection section is a strain gauge. Accordingly, the position of the flexible member can be detected in multiple stages by the detection section including the strain gauges.

In Aspect 4 which is a specific example of Aspect 3, the liquid ejecting head further includes a head chip that includes the plurality of nozzles, the common liquid chamber, the filter, the flexible member, and the detection section, the head chip includes a conductive frame member that is disposed on a side opposite to the common liquid chamber of the flexible member and defines a compliance space that allows displacement of the flexible member, and the detection section includes a beam portion that couples outer peripheral frame portions defining the compliance space of the frame member. Accordingly, the detection section is configured as a part of the frame member, so that the number of components can be reduced and the cost can be reduced.

In Aspect 5 which is a specific example of Aspect 4, the outer peripheral frame portion includes a first portion having the beam portion and a second portion in which the beam portion is not provided, and the first portion and the second portion are not conductive to each other. Accordingly, since a part of the frame member can be used as the wire of the detection section, the number of components can be reduced and the cost can be reduced.

In Aspect 6 which is a specific example of Aspect 1, a bending rigidity of the flexible member is smaller than a bending rigidity of the filter. As a result, since the amount of deformation of the flexible member due to the pressure change inside the common liquid chamber is larger than that of the filter, the large amount of deformation can be detected by providing the detection section in the flexible member, and the detection accuracy can be improved.

According to Aspect 7 as a preferred aspect, a liquid ejecting apparatus includes the liquid ejecting head according to Aspect. Accordingly, it is possible to calculate the cleaning time or the replacement time of the filter based on the filter life of the liquid ejecting head, and it is possible to suppress the sudden occurrence of the ejection failure of the liquid droplets based on the filter life, and thus it is possible to improve the reliability.

A method of detecting a state of a liquid ejecting head according to Aspect 8 as a preferred aspect is a method of detecting the state of the liquid ejecting head according to the aspect, and includes estimating a degree of clogging of the filter based on first information on a position of the flexible member detected by the detection section before a pressure applying operation of applying a pressure into the common liquid chamber is performed and second information on the position of the flexible member detected by the detection section while the pressure applying operation is performed. As a result, the clogging state of the filter can be easily detected from the outside.

In Aspect 9 which is a specific example of Aspect 8, the liquid ejecting head includes a supply flow path that makes the upstream chamber of the common liquid chamber and an introduction port for introducing a liquid from an outside of the liquid ejecting head communicate with each other, and an upstream filter provided in the middle of the supply flow path, and the pressure applying operation includes a pressurization operation of pressurizing the liquid in the common liquid chamber from upstream of the upstream filter and a depressurization operation of depressurizing the liquid in the common liquid chamber from the nozzle, and a degree of clogging of each of the filter and the upstream filter is estimated based on the first information detected before the pressure applying operation is performed, the second information detected while the pressurization operation is performed, the first information detected before the depressurization operation is performed, and the second information detected while the depressurization operation is performed. Accordingly, by performing pressurization and depressurization from the upstream of the liquid ejecting head, the clogging state of each of the upstream filter and the filter can be detected with high accuracy.

In Aspect 10 which is a specific example of Aspect 8, the liquid ejecting head includes a collection flow path that communicates with the upstream chamber of the common liquid chamber and collects the liquid from the common liquid chamber, the pressure applying operation includes a first pressurization operation of pressurizing the common liquid chamber in a state in which the collection flow path is closed, and a degree of clogging of the filter is estimated based on the first information detected before the pressure applying operation is performed and the second information detected while the first pressurization operation is performed. According to this, it is possible to detect a clogging state of the filter by preventing the pressure from escaping from the collection flow path when pressurized.

In Aspect 11 which is a specific example of Aspect 8, the liquid ejecting head includes a supply flow path that makes the upstream chamber of the common liquid chamber and an introduction port for introducing a liquid from an outside of the liquid ejecting head communicate with each other, a upstream filter provided in the middle of the supply flow path, and a collection flow path that communicates with the upstream chamber of the common liquid chamber and collects the liquid from the common liquid chamber, the pressure applying operation includes a second pressurization operation of pressurizing the common liquid chamber via the collection flow path, and a degree of clogging of the filter is estimated based on the first information detected before the pressure applying operation is performed and the second information detected while the second pressurization operation is performed. Accordingly, the clogging state of the filter can be detected because the pressure can be applied to the common liquid chamber without passing through the upstream filter.

A method of detecting a state of a liquid ejecting head according to Aspect 12 as a preferred aspect is a method of detecting the state of the liquid ejecting head according to the aspect, and includes estimating a degree of clogging of the filter based on third information on the position of the flexible member detected by the detection section while a pressure applying operation of applying a pressure into the common liquid chamber is performed at a first timing at which the filter is not clogged and fourth information on the position of the flexible member detected by the detection section while the pressure applying operation is performed at a second timing later than the first timing, thereby making it possible to easily detect the clogged state of the filter from the outside.

What is claimed is:

1. A liquid ejecting head comprising:
nozzles configured to eject a liquid;
a common liquid chamber communicating with the nozzles;
a filter partitioning the common liquid chamber into an upstream chamber and a downstream chamber;
a flexible member defining the downstream chamber of the common liquid chamber; and
a detection section configured to detect a position of the flexible member, wherein
the flexible member disposed between the downstream chamber and the detection section.

2. The liquid ejecting head according to claim 1, wherein
the detection section is disposed in a central portion of the flexible member in a longitudinal direction of the common liquid chamber.

3. The liquid ejecting head according to claim 1, wherein
the detection section is a strain gauge.

4. The liquid ejecting head according to claim 3, further comprising a head chip that includes the nozzles, the common liquid chamber, the filter, the flexible member, the detection section, and a conductive frame member defining a compliance space that allows displacement of the flexible member, wherein
the flexible member disposed between the downstream chamber and frame member, and
the detection section includes a beam portion that couples outer peripheral frame portions defining the compliance space of the frame member.

5. The liquid ejecting head according to claim 4, wherein
the outer peripheral frame portion includes a first portion having the beam portion and a second portion in which the beam portion is not provided, and
the first portion and the second portion are not conductive.

6. The liquid ejecting head according to claim 1, wherein
a bending rigidity of the flexible member is smaller than a bending rigidity of the filter.

7. The liquid ejecting head according to claim 1, wherein
the detection section is disposed on a surface of the flexible member that faces away from the downstream chamber.

8. A liquid ejecting apparatus comprising the liquid ejecting head according to claim 1

9. A method of detecting a state of the liquid ejecting head according to claim 1, the method comprising estimating a degree of clogging of the filter based on first information on a position of the flexible member detected by the detection section before a pressure applying operation of applying a pressure into the common liquid chamber is performed and second information on the position of the flexible member detected by the detection section while the pressure applying operation is performed.

10. The method of detecting a state of the liquid ejecting head according to claim 9, wherein
the liquid ejecting head includes a supply flow path that makes the upstream chamber of the common liquid chamber and an introduction port for introducing a liquid from an outside of the liquid ejecting head communicate with each other, and an upstream filter provided in the middle of the supply flow path, and
the pressure applying operation includes a pressurization operation of pressurizing the liquid in the common liquid chamber from upstream of the upstream filter and a depressurization operation of depressurizing the liquid in the common liquid chamber from the nozzle, and a degree of clogging of each of the filter and the upstream filter is estimated based on the first information detected before the pressure applying operation is performed, the second information detected while the pressurization operation is performed, and the second information detected while the depressurization operation is performed.

11. The method of detecting a state of the liquid ejecting head according to claim 9, wherein
the liquid ejecting head includes a collection flow path that communicates with the upstream chamber of the common liquid chamber and collects the liquid from the common liquid chamber,
the pressure applying operation includes a first pressurization operation of pressurizing the common liquid chamber in a state in which the collection flow path is closed, and
a degree of clogging of the filter is estimated based on the first information detected before the pressure applying operation is performed and the second information detected while the first pressurization operation is performed.

12. The method of detecting a state of the liquid ejecting head according to claim 9, wherein
the liquid ejecting head includes a supply flow path that makes the upstream chamber of the common liquid chamber and an introduction port for introducing a liquid from an outside of the liquid ejecting head communicate with each other, an upstream filter provided in the middle of the supply flow path, and a collection flow path that communicates with the upstream chamber of the common liquid chamber and collects the liquid from the common liquid chamber,
the pressure applying operation includes a second pressurization operation of pressurizing the common liquid chamber via the collection flow path, and
a degree of clogging of the filter is estimated based on the first information detected before the pressure applying operation is performed and the second information detected while the second pressurization operation is performed.

13. A method of detecting a state of the liquid ejecting head of detecting a state of the liquid ejecting head according to claim 1, the method comprising estimating a degree of clogging of the filter based on third information on the position of the flexible member detected by the detection section while a pressure applying operation of applying a pressure into the common liquid chamber is performed at a first timing at which the filter is not clogged and fourth information on the position of the flexible member detected by the detection section while the pressure applying operation is performed at a second timing later than the first timing.
